(19) United States
(12) Patent Application Publication
(10) Pub. No.: US 2024/0185004 A1
(43) Pub. Date: Jun. 6, 2024

(54) RFID TAG PARAMETER DETERMINATION USING PHASE

(71) Applicant: Impinj, Inc., Seattle, WA (US)

(72) Inventors: Austin OURSLAND, Seattle, WA (US); Rene Dominic MARTINEZ, Seattle, WA (US); Vincent C. MORETTI, Kenmore, WA (US); Pavel NIKITIN, Seattle, WA (US); Omer ONEN, Redmond, WA (US); Joe TARANTINO, Seattle, WA (US); Michael H. THOMAS, Wake Forest, NC (US); Yossi TEXERMAN, San Diego, CA (US); Scott A. COOPER, Seattle, WA (US); Christopher J. DIORIO, Shoreline, WA (US)

(73) Assignee: Impinj, Inc., Seattle, WA (US)

(21) Appl. No.: 18/567,453

(22) PCT Filed: Jun. 10, 2022
(86) PCT No.: PCT/US22/33077

§ 371 Date: Dec. 6, 2023

Related U.S. Application Data
(60) Provisional application No. 63/209,529, filed on Jun. 11, 2021.

(51) Int. Cl. G06K 7/10; G01S 13/84

(52) U.S. Cl. CPC G06K 7/10099; G01S 13/84

(57) ABSTRACT

RFID tag reply phase measurements can be used to estimate tag location and motion. The phase measurements can be used to directly calculate tag location/motion or to generate correlation probabilities with candidate tags having different location motion characteristics. An RFID reader system can take multiple phase measurements for a tag, at different carrier frequencies, within a single inventory round, to ensure that the tag remains within range of the reader system.

### BACKGROUND

Radio-Frequency Identification (RFID) systems typically include RFID readers, also known as RFID reader/writers or RFID interrogators, and RFID tags. RFID systems can be used in many ways for locating and identifying objects to which the tags are attached. RFID systems are useful in product-related and service-related industries for tracking objects being processed, inventoried, or handled. In such cases, an RFID tag is usually attached to an individual item, or to its package. The RFID tag typically includes, or is, a radio-frequency (RF) integrated circuit (IC).

In principle, RFID techniques entail using an RFID reader to inventory one or more RFID tags, where inventorying involves singulating a tag, receiving an identifier from a tag, and/or acknowledging a received identifier (e.g., by transmitting an acknowledge command). “Singulated” is defined as a reader singling-out one tag, potentially from among multiple tags, for a reader—tag dialog. “Identifier” is defined as a number identifying the tag or the item to which the tag is attached, such as a tag identifier (TID), electronic product code (EPC), etc. An “inventory round” is defined as a reader staging RFID tags for successive inventorying. The reader transmitting an RF wave performs the inventory. The RF wave is typically electromagnetic, at least in the far field. The RF wave can also be predominantly electric or magnetic in the near or transitional near field. The RF wave may encode one or more commands that instruct the tags to perform one or more actions. The operation of an RFID reader sending commands to an RFID tag is sometimes known as the reader “interrogating” the tag.

In typical RFID systems, an RFID reader transmits a modulated RF inventory signal (a command), receives a tag reply, and transmits an RF acknowledgement signal responsive to the tag reply. A tag that replies to the interrogating RF wave does so by transmitting back another RF wave. The tag either generates the transmitted back RF wave originally, or by reflecting back a portion of the interrogating RF wave in a process known as backscatter. Backscatter may take place in a number of ways.

The reflected-back RF wave may encode data stored in the tag, such as a number. The response is demodulated and decoded by the reader, which thereby identifies, counts, or otherwise interacts with the associated item. The decoded data can denote a serial number, a price, a date, a time, a destination, an encrypted message, an electronic signature, other attribute(s), any combination of attributes, and so on. Accordingly, when a reader receives tag data it can learn about the item that hosts the tag and/or about the tag itself.

An RFID tag typically includes an antenna section, a radio section, a power-management section, and frequently a logical section, a memory, or both. In some RFID tags the power-management section includes an energy storage device such as a battery. RFID tags with an energy storage device are known as battery-assisted, semi-active, or active tags. Other RFID tags can be powered solely by the RF signal they receive. Such RFID tags do not include an energy storage device and are called passive tags. Of course, even passive tags typically include temporary energy- and data/flag-storage elements such as capacitors or inductors.

### BRIEF SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to using RFID tag reply phase measurements to estimate tag location and motion. The phase measurements can be used to directly calculate tag location/motion or to generate correlation probabilities with candidate tags having different location/motion characteristics. An RFID reader system can take multiple phase measurements for a tag, at different carrier frequencies, within a single inventory round, to ensure that the tag remains within range of the reader system.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The following Detailed Description proceeds with reference to the accompanying drawings, in which:

FIG. 1 is a block diagram of components of an RFID system.

FIG. 2 is a diagram showing components of a passive RFID tag, such as a tag that can be used in the system of FIG. 1.

FIG. 3 is a conceptual diagram for explaining a half-duplex mode of communication between the components of the RFID system of FIG. 1.

FIG. 4 is a block diagram showing a detail of an RFID tag, such as the one shown in FIG. 2.

FIG. 5A and 5B illustrate signal paths during tag-to-reader and reader-to-tag communications in the block diagram of FIG. 4.

FIG. 6 is a block diagram showing a detail of an RFID reader system, such as the one shown in FIG. 1.

FIG. 7 depicts tag parameter determination using phase, according to embodiments.

FIG. 8 depicts components of an RFID reader system, according to embodiments.

FIG. 9 depicts how an RFID reader transceiver can be calibrated using a static reflection, according to embodiments.

FIG. 10 depicts how an RFID reader transceiver can be calibrated using a dynamic reflection, according to embodiments.

FIG. 11 depicts how an RFID reader system can be calibrated using a dynamic reflection in a radiated environment, according to embodiments.

FIG. 12 depicts how RFID tag parameters can be determined by correlation to candidates, according to embodiments.

FIG. 13 depicts diagrams of how correlation may be used to determine RFID tag ranges, according to embodiments.

FIG. 14 depicts example baseband, modulating, and modulated waveforms at an RFID reader according to embodiments.

FIG. 15 depicts delimiter symbols according to the Gen2 Protocol.

### DETAILED DESCRIPTION

In the following detailed description, references are made to the accompanying drawings that form a part hereof, and in which are shown by way of illustration specific embodiments or examples. These embodiments or examples may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

As used herein, “memory” is one of ROM, RAM, SRAM, DRAM, NVM, EEPROM, FLASH, Fuse, MRAM, FRAM, and other similar volatile and nonvolatile information-storage technologies. Some portions of memory may be writeable and some not. “Instruction” refers to a request to a tag to perform a single explicit action (e.g., write data into memory). “Command” refers to a reader request for one or more tags to perform one or more actions, and includes one or more tag instructions preceded by a command identifier or command code that identifies the command and/or the tag instructions. “Program” refers to a request to a tag to perform a set or sequence of instructions (e.g., read a value from memory and, if the read value is less than a threshold then lock a memory word). “Protocol” refers to an industry standard for communications between a reader and a tag (and vice versa), such as the Class-1 Generation-2 UHF RFID Protocol for Communications at 860 MHz-960 MHz by GS1 EPCglobal, Inc. (“Gen2 Protocol”), versions 1.2.0, 2.0, and 2.0.1 of which are hereby incorporated by reference.

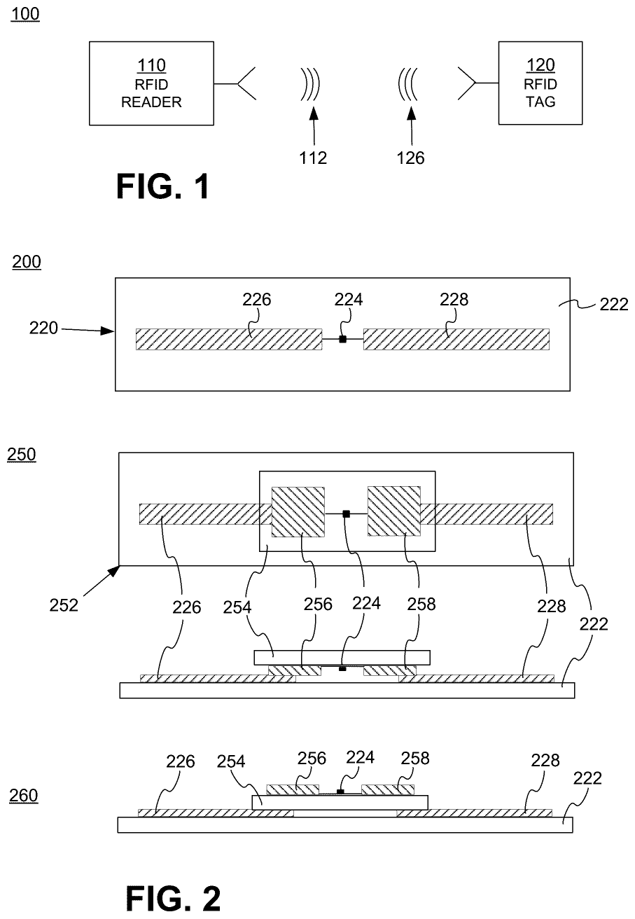

FIG. 1 is a diagram of the components of a typical RFID system 100, incorporating embodiments. An RFID reader 110 and a nearby RFID tag 120 communicate via RF signals 112 and 126. When sending data to tag 120, reader 110 may generate RF signal 112 by encoding the data, modulating an RF waveform with the encoded data, and transmitting the modulated RF waveform as RF signal 112. In turn, tag 120 may receive RF signal 112, demodulate encoded data from RF signal 112, and decode the encoded data. Similarly, when sending data to reader 110 tag 120 may generate RF signal 126 by encoding the data, modulating an RF waveform with the encoded data, and causing the modulated RF waveform to be sent as RF signal 126. The data sent between reader 110 and tag 120 may be represented by symbols, also known as RFID symbols. A symbol may be a delimiter, a calibration value, or implemented to represent binary data, such as “0” and “1”, if desired. Upon processing by reader 110 and tag 120, symbols may be treated as values, numbers, or any other suitable data representations.

The RF waveforms transmitted by reader 110 and/or tag 120 may be in a suitable range of frequencies, such as those near 900 MHz, 13.56 MHz, or similar. In some embodiments, RF signals 112 and/or 126 may include non-propagating RF signals, such as reactive near-field signals or similar RFID tag 120 may be active or battery-assisted (i.e., possessing its own power source), or passive. In the latter case, RFID tag 120 may harvest power from RF signal 112.

FIG. 2 is a diagram 200 of an RFID tag 220, which may function as tag 120 of FIG. 1. Tag 220 may be formed on a substantially planar inlay 222, which can be made in any suitable way. Tag 220 includes a circuit which may be implemented as an IC 224. In some embodiments IC 224 is fabricated in complementary metal-oxide semiconductor (CMOS) technology. In other embodiments IC 224 may be fabricated in other technologies such as bipolar junction transistor (BJT) technology, metal-semiconductor field-effect transistor (MESFET) technology, and others as will be well known to those skilled in the art. IC 224 is arranged on inlay 222.

Tag 220 also includes an antenna for transmitting and/or interacting with RF signals. In some embodiments the antenna can be etched, deposited, and/or printed metal on inlay 222; conductive thread formed with or without substrate 222; nonmetallic conductive (such as graphene) patterning on substrate 222; a first antenna coupled inductively, capacitively, or galvanically to a second antenna; or can be fabricated in myriad other ways that exist for forming antennas to receive RF waves. In some embodiments the antenna may even be formed in IC 224. Regardless of the antenna type, IC 224 is electrically coupled to the antenna via suitable IC contacts (not shown in FIG. 2). The term “electrically coupled” as used herein may mean a direct electrical connection, or it may mean a connection that includes one or more intervening circuit blocks, elements, or devices. The “electrical” part of the term “electrically coupled” as used in this document shall mean a coupling that is one or more of ohmic/galvanic, capacitive, and/or inductive Similarly, the terms “electrically isolated” or “electrically decoupled” as used herein mean that electrical coupling of one or more types (e.g., galvanic, capacitive, and/or inductive) is not present, at least to the extent possible. For example, elements that are electrically isolated from each other are galvanically isolated from each other, capacitively isolated from each other, and/or inductively isolated from each other. Of course, electrically isolated components will generally have some unavoidable stray capacitive or inductive coupling between them, but the intent of the isolation is to minimize this stray coupling when compared with an electrically coupled path.

IC 224 is shown with a single antenna port, comprising two IC contacts electrically coupled to two antenna segments 226 and 228 which are shown here forming a dipole. Many other embodiments are possible using any number of ports, contacts, antennas, and/or antenna segments. Antenna segments 226 and 228 are depicted as separate from IC 224, but in other embodiments the antenna segments may alternatively be formed on IC 224. Tag antennas according to embodiments may be designed in any form and are not limited to dipoles. For example, the tag antenna may be a patch, a slot, a loop, a coil, a horn, a spiral, a monopole, microstrip, stripline, or any other suitable antenna.

Diagram 250 depicts top and side views of tag 252, formed using a strap. Tag 252 differs from tag 220 in that it includes a substantially planar strap substrate 254 having strap contacts 256 and 258. IC 224 is mounted on strap substrate 254 such that the IC contacts on IC 224 electrically couple to strap contacts 256 and 258 via suitable connections (not shown). Strap substrate 254 is then placed on inlay 222 such that strap contacts 256 and 258 electrically couple to antenna segments 226 and 228. Strap substrate 254 may be affixed to inlay 222 via pressing, an interface layer, one or more adhesives, or any other suitable means.

Diagram 260 depicts a side view of an alternative way to place strap substrate 254 onto inlay 222. Instead of strap substrate 254′s surface, including strap contacts 256/258, facing the surface of inlay 222, strap substrate 254 is placed with its strap contacts 256/258 facing away from the surface of inlay 222. Strap contacts 256/258 can then be either capacitively coupled to antenna segments 226/228 through strap substrate 254, or conductively coupled using a through-via which may be formed by crimping strap contacts 256/258 to antenna segments 226/228. In some embodiments, the positions of strap substrate 254 and inlay 222 may be reversed, with strap substrate 254 mounted beneath inlay 222 and strap contacts 256/258 electrically coupled to antenna segments 226/228 through inlay 222. Of course, in yet other embodiments strap contacts 256/258 may electrically couple to antenna segments 226/228 through both inlay 222 and strap substrate 254.

In operation, the antenna couples with RF signals in the environment and propagates the signals to IC 224, which may both harvest power and respond if appropriate, based on the incoming signals and the IC's internal state. If IC 224 uses backscatter modulation then it may generate a response signal (e.g., signal 126) from an RF signal in the environment (e.g., signal 112) by modulating the antenna's reflectance. Electrically coupling and uncoupling the IC contacts of IC 224 can modulate the antenna's reflectance, as can varying the admittance or impedance of a shunt-connected or series-connected circuit element which is coupled to the IC contacts. If IC 224 is capable of transmitting signals (e.g., has its own power source, is coupled to an external power source, and/or can harvest sufficient power to transmit signals), then IC 224 may respond by transmitting response signal 126. In the embodiments of FIG. 2, antenna segments 226 and 228 are separate from IC 224. In other embodiments, the antenna segments may alternatively be formed on IC 224.

An RFID tag such as tag 220 is often attached to or associated with an individual item or the item packaging. An RFID tag may be fabricated and then attached to the item or packaging, may be partly fabricated before attachment to the item or packaging and then completely fabricated upon attachment to the item or packaging, or the manufacturing process of the item or packaging may include the fabrication of the RFID tag. In some embodiments, the RFID tag may be integrated into the item or packaging. In this case, portions of the item or packaging may serve as tag components. For example, conductive item or packaging portions may serve as tag antenna segments or contacts. Nonconductive item or packaging portions may serve as tag substrates or inlays. If the item or packaging includes integrated circuits or other circuitry, some portion of the circuitry may be configured to operate as part or all of an RFID tag IC. Thus, an “RFID IC” need not be distinct from an item, but more generally refers to the item containing an RFID IC and antenna capable of interacting with RF waves and receiving and responding to RFID signals. Because the boundaries between IC, tag, and item are thus often blurred, the terms “RFID IC”, “RFID tag”, “tag”, or “tag IC” as used herein may refer to the IC, the tag, or even to the item as long as the referenced element is capable of RFID functionality.

The components of the RFID sstem of FIG. 1 may communicate with each other in any number of modes. One such mode is called full duplex, where both reader 110 and tag 120 can transmit at the same time. In some embodiments, RFID system 100 may be capable of full duplex communication. Another such mode, which may be more suitable for passive tags, is called half-duplex, and is described below.

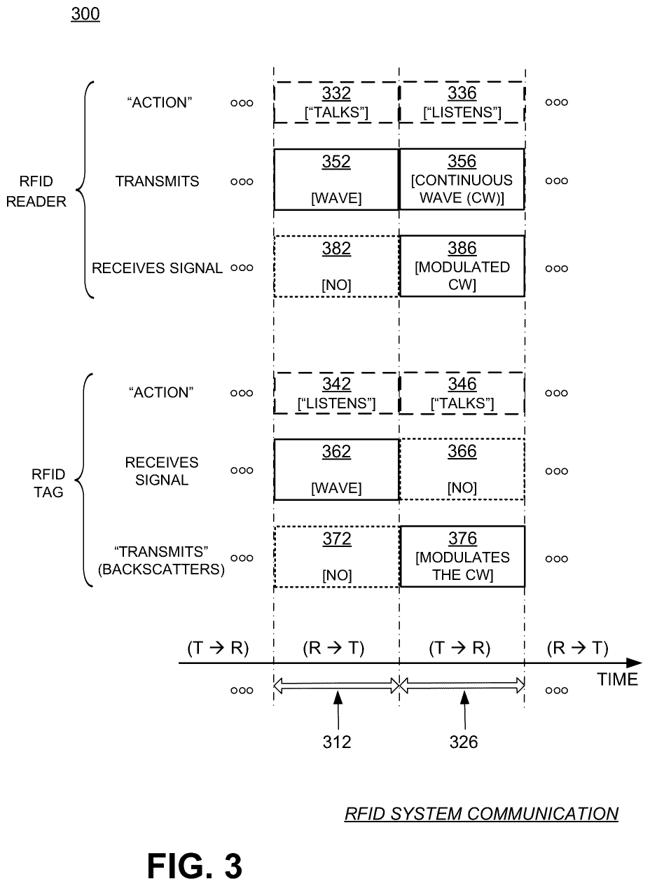

FIG. 3 is a conceptual diagram 300 for explaining half-duplex communications between the components of the RFID system of FIG. 1, in this case with tag 120 implemented as a passive tag. The explanation is made with reference to a TIME axis, and also to a human metaphor of “talking” and “listening”. The actual technical implementations for “talking” and “listening” are now described.

In a half-duplex communication mode, RFID reader 110 and RFID tag 120 talk and listen to each other by taking turns. As seen on axis TIME, reader 110 talks to tag 120 during intervals designated “R→T”, and tag 120 talks to reader 110 during intervals designated “T→R”. For example, a sample R→T interval occurs during time interval 312, during which reader 110 talks (block 332) and tag 120 listens (block 342). A following sample T→R interval occurs during time interval 326, during which reader 110 listens (block 336) and tag 120 talks (block 346). Interval 312 may be of a different duration than interval 326—here the durations are shown approximately equal only for purposes of illustration.

During interval 312, reader 110 transmits a signal such as signal 112 described in FIG. 1 (block 352), while tag 120 receives the reader signal (block 362), processes the reader signal to extract data, and harvests power from the reader signal. While receiving the reader signal, tag 120 does not backscatter (block 372), and therefore reader 110 does not receive a signal from tag 120 (block 382).

During interval 326, also known as a backscatter time interval or backscatter interval, reader 110 does not transmit a data-bearing signal. Instead, reader 110 transmits a continuous wave (CW) signal, which is a carrier that generally does not encode information. The CW signal provides energy for tag 120 to harvest as well as a waveform that tag 120 can modulate to form a backscatter response signal. Accordingly, during interval 326 tag 120 is not receiving a signal with encoded information (block 366) and instead modulates the CW signal (block 376) to generate a backscatter signal such as signal 126 described in FIG. 2. Tag 120 may modulate the CW signal to generate a backscatter signal by adjusting its antenna reflectance, as described above. Reader 110 then receives and processes the backscatter signal (block 386).

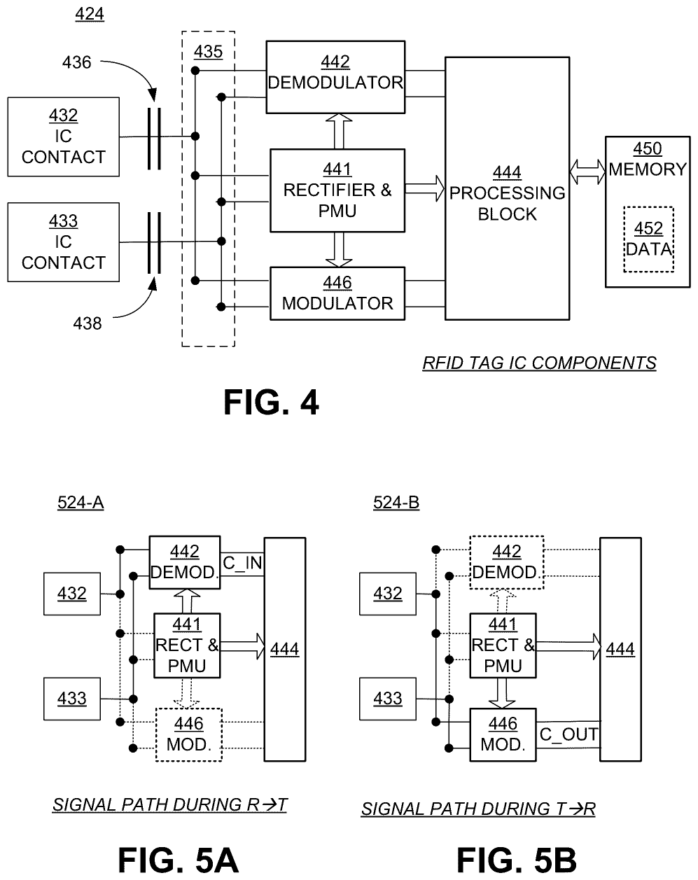

FIG. 4 is a block diagram showing a detail of an RFID IC, such as IC 224 in FIG. 2. Electrical circuit 424 may be implemented in an IC, such as IC 224. Circuit 424 implements at least two IC contacts 432 and 433, suitable for coupling to antenna segments such as antenna segments 226/228 in FIG. 2. When two IC contacts form the signal input from and signal return to an antenna they are often referred-to as an antenna port. IC contacts 432 and 433 may be made in any suitable way, such as from electrically-conductive pads, bumps, or similar. In some embodiments circuit 424 implements more than two IC contacts, especially when configured with multiple antenna ports and/or to couple to multiple antennas.

Circuit 424 includes signal-routing section 435 which may include signal wiring, signal-routing busses, receive/transmit switches, and similar that can route signals between the components of circuit 424. IC contacts 432/433 may couple galvanically, capacitively, and/or inductively to signal-routing section 435. For example, optional capacitors 436 and/or 438 may capacitively couple IC contacts 432/433 to signal-routing section 435, thereby galvanically decoupling IC contacts 432/433 from signal-routing section 435 and other components of circuit 424.

Capacitive coupling (and the resultant galvanic decoupling) between IC contacts 432 and/or 433 and components of circuit 424 is desirable in certain situations. For example, in some RFID tag embodiments IC contacts 432 and 433 may galvanically connect to terminals of a tuning loop on the tag. In these embodiments, galvanically decoupling IC contact 432 from IC contact 433 may prevent the formation of a DC short circuit between the IC contacts through the tuning loop.

Capacitors 436/438 may be implemented within circuit 424 and/or partly or completely external to circuit 424. For example, a dielectric or insulating layer on the surface of the IC containing circuit 424 may serve as the dielectric in capacitor 436 and/or capacitor 438. As another example, a dielectric or insulating layer on the surface of a tag substrate (e.g., inlay 222 or strap substrate 254) may serve as the dielectric in capacitors 436/438. Metallic or conductive layers positioned on both sides of the dielectric layer (i.e., between the dielectric layer and the IC and between the dielectric layer and the tag substrate) may then serve as terminals of the capacitors 436/438. The conductive layers may include IC contacts (e.g., IC contacts 432/433), antenna segments (e.g., antenna segments 226/228), or any other suitable conductive layers.

Circuit 424 includes a rectifier and PMU (Power Management Unit) 441 that harvests energy from the RF signal incident on antenna segments 226/228 to power the circuits of IC 424 during either or both reader-to-tag (R→T) and tag-to-reader (T→R) intervals. Rectifier and PMU 441 may be implemented in any way known in the art, and may include one or more components configured to convert an alternating-current (AC) or time-varying signal into a direct-current (DC) or substantially time-invariant signal.

Circuit 424 also includes a demodulator 442, a processing block 444, a memory 450, and a modulator 446. Demodulator 442 demodulates the RF signal received via IC contacts 432/433, and may be implemented in any suitable way, for example using a slicer, an amplifier, and other similar components. Processing block 444 receives the output from demodulator 442, performs operations such as command decoding, memory interfacing, and other related operations, and may generate an output signal for transmission. Processing block 444 may be implemented in any suitable way, for example by combinations of one or more of a processor, memory, decoder, encoder, and other similar components. Memory 450 stores data 452, and may be at least partly implemented as permanent or semi-permanent memory such as nonvolatile memory (NVM), EEPROM, ROM, or other memory types configured to retain data 452 even when circuit 424 does not have power. Processing block 444 may be configured to read data from and/or write data to memory 450.

Modulator 446 generates a modulated signal from the output signal generated by processing block 444. In one embodiment, modulator 446 generates the modulated signal by driving the load presented by antenna segment(s) coupled to IC contacts 432/433 to form a backscatter signal as described above. In another embodiment, modulator 446 includes and/or uses a transmitter to generate and transmit the modulated signal via antenna segment(s) coupled to IC contacts 432/433. Modulator 446 may be implemented in any suitable way, for example using a switch, driver, amplifier, and other similar components. Demodulator 442 and modulator 446 may be separate components, combined in a single transceiver circuit, and/or part of processing block 444.

In some embodiments, particularly in those with more than one antenna port, circuit 424 may contain multiple demodulators, rectifiers, PMUs, modulators, processing blocks, and/or memories.

FIG. 5A shows version 524-A of components of circuit 424 of FIG. 4, further modified to emphasize a signal operation during a R→T interval (e.g., time interval 312 of FIG. 3). During the R→T interval, demodulator 442 demodulates an RF signal received from IC contacts 432/433. The demodulated signal is provided to processing block 444 as C_IN, which in some embodiments may include a received stream of symbols. Rectifier and PMU 441 may be active, for example harvesting power from an incident RF waveform and providing power to demodulator 442, processing block 444, and other circuit components. During the R→T interval, modulator 446 is not actively modulating a signal, and in fact may be decoupled from the RF signal. For example, signal routing section 435 may be configured to decouple modulator 446 from the RF signal, or an impedance of modulator 446 may be adjusted to decouple it from the RF signal.

FIG. 5B shows version 524-B of components of circuit 424 of FIG. 4, further modified to emphasize a signal operation during a T→R interval (e.g., time interval 326 of FIG. 3). During the T→R interval, processing block 444 outputs a signal C_OUT, which may include a stream of symbols for transmission. Modulator 446 then generates a modulated signal from C_OUT and sends the modulated signal via antenna segment(s) coupled to IC contacts 432/433, as described above. During the T→R interval, rectifier and PMU 441 may be active, while demodulator 442 may not be actively demodulating a signal. In some embodiments, demodulator 442 may be decoupled from the RF signal during the T→R interval. For example, signal routing section 435 may be configured to decouple demodulator 442 from the RF signal, or an impedance of demodulator 442 may be adjusted to decouple it from the RF signal.

In typical embodiments, demodulator 442 and modulator 446 are operable to demodulate and modulate signals according to a protocol, such as the Gen2 Protocol mentioned above. In embodiments where circuit 424 includes multiple demodulators modulators, and/or processing blocks, each may be configured to support different protocols or different sets of protocols. A protocol specifies, in part, symbol encodings, and may include a set of modulations, rates, timings, or any other parameter associated with data communications. A protocol can be a variant of an internationally ratified protocol such as the Gen2 Protocol, for example including fewer or additional commands than the ratified protocol calls for, and so on. In some instances, additional commands may sometimes be called custom commands

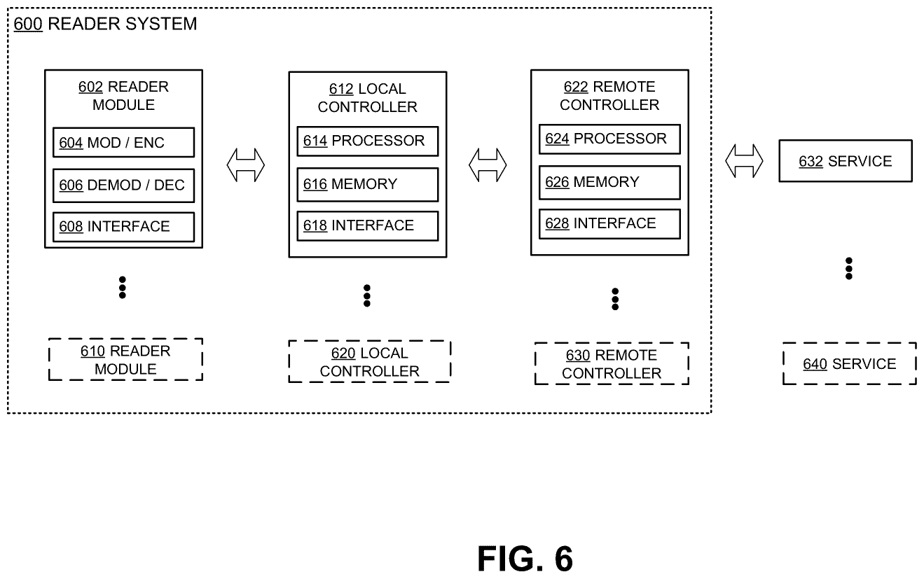

FIG. 6 depicts an RFID reader system 600 according to embodiments. Reader system 600 is configured to communicate with RFID tags and optionally to communicate with entities external to reader system 600, such as a service 632. Reader system 600 includes at least one reader module 602, configured to transmit signals to and receive signals from RFID tags. Reader system 600 further includes at least one local controller 612, and in some embodiments includes at least one remote controller 622. Controllers 612 and/or 622 are configured to control the operation of reader module 602, process data received from RFID tags communicating through reader module 602, communicate with external entities such as service 632, and otherwise control the operation of reader system 600.

In some embodiments, reader system 600 may include multiple reader modules, local controllers, and/or remote controllers. For example, reader system 600 may include at least one other reader module 610, at least one other local controller 620, and/or at least one other remote controller 630. A single reader module may communicate with multiple local and/or remote controllers, a single local controller may communicate with multiple reader modules and/or remote controllers, and a single remote controller may communicate with multiple reader modules and/or local controllers. Similarly, reader system 600 may be configured to communicate with multiple external entities, such as other reader systems (not depicted) and multiple services (for example, services 632 and 640).

Reader module 602 includes a modulator/encoder block 604, a demodulator/decoder block 606, and an interface block 608. Modulator/encoder block 604 may encode and modulate data for transmission to RFID tags. Demodulator/decoder block 606 may demodulate and decode signals received from RFID tags to recover data sent from the tags. The modulation, encoding, demodulation, and decoding may be performed according to a protocol or specification, such as the Gen2 Protocol. Reader module 602 may use interface block 608 to communicate with local controller 612 and/or remote controller 622, for example to exchange tag data, receive instructions or commands, or to exchange other relevant information.

Reader module 602 and blocks 604/606 are coupled to one or more antennas and/or antenna drivers (not depicted), for transmitting and receiving RF signals. In some embodiments, reader module 602 is coupled to multiple antennas and/or antenna drivers. In these embodiments, reader module 602 may transmit and/or receive RF signals on the different antennas in any suitable scheme. For example, reader module 602 may switch between different antennas to transmit and receive RF signals, transmit on one antenna but receive on another antenna, or transmit and/or receive on multiple antennas simultaneously. In some embodiments, reader module 602 may be coupled to one or more phased-array or synthesized-beam antennas whose beams can be generated and/or steered, for example by reader module 602, local controller 612, and/or remote controller 622.

Modulator/encoder block 604 and/or demodulator/decoder block 606 may be configured to perform conversion between analog and digital signals. For example, modulator/encoder block 604 may convert a digital signal received via interface block 608 to an analog signal for subsequent transmission, and demodulator/decoder block 606 may convert a received analog signal to a digital signal for transmission via interface block 608.

Local controller 612 includes a processor block 614, a memory 616, and an interface 618. Remote controller 622 includes a processor block 624, a memory 626, and an interface 628. Local controller 612 differs from remote controller 622 in that local controller 612 is collocated or at least physically near reader module 602, whereas remote controller 622 is not physically near reader module 602.

Processor blocks 614 and/or 624 may be configured to, alone or in combination, provide different functions. Such functions may include the control of other components, such as memory, interface blocks, reader modules, and similar; communication with other components such as reader module 602, other reader systems, services 632/640, and similar; data-processing or algorithmic processing such as encryption, decryption, authentication, and similar; or any other suitable function. In some embodiments, processor blocks 614/624 may be configured to convert analog signals to digital signals or vice-versa, as described above in relation to blocks 604/606; processor blocks 614/624 may also be configured to perform any suitable analog signal processing or digital signal processing, such as filtering, carrier cancellation, noise determination, and similar.

Processor blocks 614/624 may be configured to provide functions by execution of instructions or applications, which may be retrieved from memory (for example, memory 616 and/or 626) or received from some other entity. Processor blocks 614/624 may be implemented in any suitable way. For example, processor blocks 614/624 may be implemented using digital and/or analog processors such as microprocessors and digital-signal processors (DSPs); controllers such as microcontrollers; software running in a machine such as a general purpose computer; programmable circuits such as field programmable gate arrays (FPGAs), field-programmable analog arrays (FPAAs), programmable logic devices (PLDs), application specific integrated circuits (ASIC), any combination of one or more of these; and equivalents.

Memories 616/626 are configured to store information, and may be implemented in any suitable way, such as the memory types described above, any combination thereof, or any other known memory or information storage technology. Memories 616/626 may be implemented as part of their associated processor blocks (e.g., processor blocks 614/624) or separately. Memories 616/626 may store instructions, programs, or applications for processor blocks 614/624 to execute. Memories 616/626 may also store other data, such as files, media, component configurations or settings, etc.

In some embodiments, memories 616/626 store tag data. Tag data may be data read from tags, data to be written to tags, and/or data associated with tags or tagged items. Tag data may include identifiers for tags such as electronic product codes (EPCs), tag identifiers (TIDs), or any other information suitable for identifying individual tags. Tag data may also include tag passwords, tag profiles, tag cryptographic keys (secret or public), tag key generation algorithms, and any other suitable information about tags or items associated with tags.

Memories 616/626 may also store information about how reader system 600 is to operate. For example, memories 616/626 may store information about algorithms for encoding commands for tags, algorithms for decoding signals from tags, communication and antenna operating modes, encryption/authentication algorithms, tag location and tracking algorithms, cryptographic keys and key pairs (such as public/private key pairs) associated with reader system 600 and/or other entities, electronic signatures, and similar

Interface blocks 608, 618, and 628 are configured to communicate with each other and with other suitably configured interfaces. The communications between interface blocks occur via the exchange of signals containing data, instructions, commands, or any other suitable information. For example, interface block 608 may receive data to be written to tags, information about the operation of reader module 602 and its constituent components, and similar; and may send data read from tags. Interface blocks 618 and 628 may send and receive tag data, information about the operation of other components, other information for enabling local controller 612 and remote controller 622 to operate in conjunction, and similar Interface blocks 608/618/628 may also communicate with external entities, such as services 632, 640, other services, and/or other reader systems.

Interface blocks 608/618/628 may communicate using any suitable wired or wireless means. For example, interface blocks 608/618/628 may communicate over circuit traces or interconnects, or other physical wires or cables, and/or using any suitable wireless signal propagation technique. In some embodiments, interface blocks 608/618/628 may communicate via an electronic communications network, such as a local area network (LAN), a metropolitan area network (MAN), a wide area network (WAN), a network of networks such as the internet. Communications from interface blocks 608/618/628 may be secured, for example via encryption and other electronic means, or may be unsecured.

Reader system 600 may be implemented in any suitable way. One or more of the components in reader system 600 may be implemented as integrated circuits using CMOS technology, BJT technology, MESFET technology, and/or any other suitable physical implementation technology. Components may also be implemented as software executing on general-purpose or application-specific hardware.

In one embodiment, a “reader” as used in this disclosure may include at least one reader module like reader module 602 and at least one local controller such as local controller 612. Such a reader may or may not include any remote controllers such as remote controller 622. A reader including a reader module and a local controller may be implemented as a standalone device or as a component in another device. In some embodiments, a reader may be implemented as a mobile device, such as a handheld reader, or as a component in a mobile device such as a laptop, tablet, smartphone, wearable device, or any other suitable mobile device.

Remote controller 622, if not included in a reader, may be implemented separately. For example, remote controller 622 may be implemented as a local host, a remote server, or a database, coupled to one or more readers via one or more communications networks. In some embodiments, remote controller 622 may be implemented as an application executing on a cloud or at a datacenter.

Functionality within reader system 600 may be distributed in any suitable way. For example, the encoding and/or decoding functionalities of blocks 604 and 606 may be performed by processor blocks 614 and/or 624. In some embodiments, processor blocks 614 and 624 may cooperate to execute an application or perform some functionality. One of local controller 612 and remote controller 622 may not implement memory, with the other controller providing memory.

Reader system 600 may communicate with at least one service 632. Service 632 provides one or more features, functions, and/or capabilities associated with one or more entities, such as reader systems, tags, tagged items, and similar. Such features, functions, and/or capabilities may include the provision of information associated with the entity, such as warranty information, repair/replacement information, upgrade/update information, and similar; and the provision of services associated with the entity, such as storage and/or access of entity-related data, location tracking for the entity, entity security services (e.g., authentication of the entity), entity privacy services (e.g., who is allowed access to what information about the entity), and similar Service 632 may be separate from reader system 600, and the two may communicate via one or more networks.

In some embodiments, an RFID reader or reader system implements the functions and features described above at least partly in the form of firmware, software, or a combination, such as hardware or device drivers, an operating system, applications, and the like. In some embodiments, interfaces to the various firmware and/or software components may be provided. Such interfaces may include application programming interfaces (APIs), libraries, user interfaces (graphical and otherwise), or any other suitable interface. The firmware, software, and/or interfaces may be implemented via one or more processor blocks, such as processor blocks 614/624. In some embodiments, at least some of the reader or reader system functions and features can be provided as a service, for example, via service 632 or service 640.

RFID systems are often used to track RFID-tagged items. RFID systems may track an item having a tag by determining the location of the tag, whether the tag is moving or stationary, and if the tag is moving its velocity (i.e, its speed and direction of movement). An RFID system can determine a tag's location given (1) a distance from an RFID reader antenna to the tag (referred to as “range”) and (2) a direction from the RFID reader antenna to the tag. The RFID system can further determine tag velocity based on the tag's location as a function of time.

An RFID system can determine an RFID tag's range and/or motion based on the propagation characteristics of reader-transmitted signals and/or reply signals backscattered by the tag using the reader-transmitted signals. For example, the RFID system can cause an RFID reader to transmit signals having known frequencies and phases. The RFID tag will generate tag reply signals by backscattering the reader-transmitted signals. The backscattered tag reply signals will have different phases with respect to the reader-transmitted signals, and the RFID system can use these different phases along with the known frequencies and phases of the reader-transmitted signals to estimate one or more parameters of the RFID tag, such as its range from the RFID reader, whether it is moving, and if so the direction and/or speed of the movement. In this disclosure, a “phase” or “phase measurement” of a tag reply refers to the difference between the measured phase of the tag reply and the phase of the original reader-transmitted signal upon which the tag reply is backscattered.

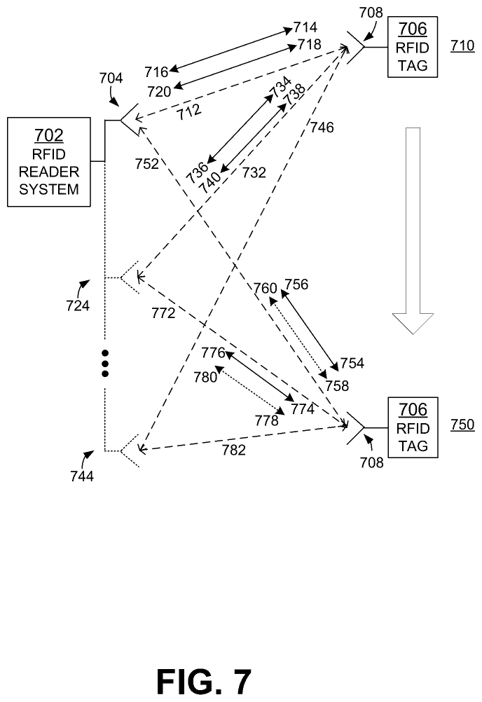

FIG. 7 depicts tag parameter determination using phase, according to embodiments. An RFID reader system 702 is configured to communicate with RFID tag 706 using one or more antennas 704, 724, and 744. At a first time, tag 706 is at location 710 such that tag antenna 708 is disposed at a distance 712 from antenna 704, a distance 732 from antenna 724, and a distance 746 from antenna 744. In this disclosure, the distance or range between two antennas is measured from the phase centers of each antenna. Reader system 702 may first transmit a first signal 714 having a first frequency and then subsequently transmit a signal 718 having a second frequency. While reader system 702 is transmitting the first signal 714, tag 706 backscatters on the first signal 714 a reply signal 716 having the same first frequency as first signal 714 but with a first phase with respect to first signal 714, where the first phase is dependent on at least the distance 712 Similarly, while reader system 702 is transmitting second signal 718, tag 706 backscatters on second signal 718 a reply signal 720 having the same second frequency as second signal 718 but with a second phase with respect to second signal 718, where the second phase is dependent at least on the distance 712. The reader system 702 can then estimate distance 712 using the following equation:

$$FR = - \frac{c Δφ}{4 πΔ f}$$

where R is tag range, c is the speed of light, Δφ is the difference between the first and second phases (in reply signals 716 and 720, respectively), and Δf is the difference between the first and second frequencies (of first signal 714 and second signal 718, respectively).

With only antenna 704, reader system 702 can estimate distance 712, thereby localizing tag 706 and antenna 708 to a spherical shell centered on antenna 704. If reader system 702 uses additional antennas, the location of tag 706 and antenna 708 can be refined further. For example, reader system 702 may transmit signals 734 and 738 from antenna 724, each having a different frequency, and may receive reply signals 736 and 740 from tag 706 backscattered on signals 734 and 738, respectively. Reply signal 736 will have a phase with respect to signal 734, while reply signal 740 will have a phase with respect to signal 740, where the phases are dependent on at least the distance 732. The reader system 702 can then estimate distance 732 using the above equation and localize tag 706 and antenna 708 to a spherical shell centered on antenna 724. If the relative and absolute positions of antennas 704 and 724 are known, tag 706 and antenna 708 can then be localized to a circle formed by the combination of the two spherical shells centered on antennas 704 and 724. If signals on a third antenna, such as antenna 744, are then used to determine phases, then tag 706 and antenna 708 can be further localized, depending on the location of the third antenna with respect to the other two antennas.

In addition to tag location, reader system 702 may be able to estimate other tag parameters such as motion or velocity. Referring again to FIG. 7, suppose that tag 706 has moved from location 710 to location 750. At location 750, tag antenna 708 is now disposed at a distance 752 from antenna 704, a distance 772 from antenna 724, and a distance 782 from antenna 744. While tag 706 is at location 750, reader system 702 transmits signal 754 and optional signal 758, having third and fourth frequencies, respectively. Tag 706 then backscatters on signal 754 a reply signal 756 having the same third frequency but with a third phase with respect to signal 754 and dependent at least on distance 752. If reader system 702 transmits optional signal 758, then tag 706 may backscatter on signal 758 a reply signal 760 having the same fourth frequency but with a fourth phase with respect to signal 758 and dependent at least on distance 752. If the third or fourth frequencies are the same or similar to the first frequency of first signal 714 or the second frequency of second signal 718, the reader system 702 may be able to directly compare the corresponding, similar phases to determine that tag 706 has moved or is in motion. Further, if the third and fourth frequencies are different, then the reader system 702 can use the third and fourth phases to estimate distance 752, as described above for distance 712.

In some embodiments, reader system 702 can bolster the tag parameter determination at location 750 using additional antennas. For example, reader system 702 may transmit signal 774 and optional signal 778 from antenna 724, receive backscattered signals 776 and 780 from tag 706 on signals 774 and 778, respectively, and determine phases of signals 776/780 with respect to signals 774/778. Reader system 702 can compare the determined phases to each other (if signals 774 and 778 have different frequencies) or to the phases of signals 736/740 to estimate distance 772 and/or the motion of tag 706. Reader system 702 can then use the distance/motion estimations performed on antenna 724 in combination with the distance/motion estimations performed on antenna 704 to refine the estimation of tag 706's location and/or motion. If other antennas (e.g., antenna 744) are available, then reader system 702 can perform phase measurements on those antennas to further refine tag location/motion estimation.

The phase of a tag reply signal received by a reader system depends not only on the frequency of the signal and the distance between the reader system and the tag, but is also affected (added to or subtracted from) by the reader system and/or the tag.

This change of the phase by the reader or tag system can be referred to as “additive phase”. Characterization (also referred to as “calibration”) of the additive phase for the reader system or tag can allow an RFID system to remove or compensate for (in a process that can be referred to as “compensation”) the effective change of phase on the radio wave to more accurately determine (a) the propagation distance of the radio wave and (b) the tag location.

An RFID reader system typically includes a transmitter, a receiver, one or more antennas, and RF cables that connect the antennas to the transmitter/receiver. In many situations, the additive phase of the reader system is non-linear with respect to frequency, and regardless of linearity, both the RF cables and the reader device itself may contribute significantly to the additive phase.

The following description uses the terms additive phase and phase delay interchangeably to indicate the same phenomenon. To be specific, a delay, τ, equals the derivative of phase, ϕ, with respect to angular frequency, ω, of the radio wave: τ=∂φ/∂ω.

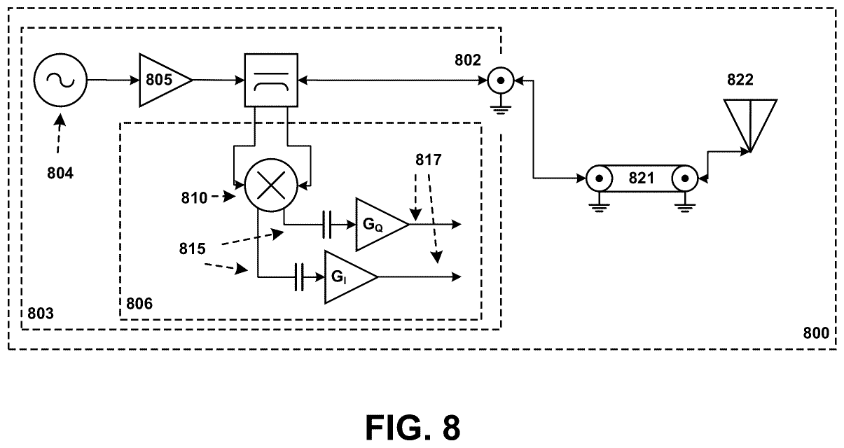

FIG. 8 depicts components of an RFID reader system 800 according to embodiments. RFID reader system 800 includes a reader transceiver 803 with an antenna port 802. The antenna port 802 couples to an antenna 822 through RF cable 821. The reader transceiver 803 includes a transmitter 805, a receiver 806, and a frequency generator 804. The frequency generator 804 provides an operating frequency for the reader transceiver 803. The receiver 806 includes a demodulator 810 with DC-coupled outputs 815 and AC-coupled outputs 817.

Additive phase in reader system 800 may result from delays in any of its components. In some embodiments, delay for each component can be characterized individually, and then the individual delays can be combined (e.g., added or summed) to determine the total delay and additive phase for reader system 800. In other embodiments, two or more components of reader system 800 can be combined, and delay for the combination may be characterized. The additive phase of a reader system, ϕ_{rdr}, over a frequency range, Δf, at an operating frequency, f, relates to total delay of the reader system, τ_{rdr}:

ϕ_{rdr}(f)=τ_{rdr}(f)·2πΔf

In some embodiments, a vector network analyzer (VNA) device can be used to measure delay of RF components, such as the RF cables and antennas. For example, a VNA can be used to measure the delay from a certain antenna using another reference antenna with a known delay and phase center.

The delay from the reader transceiver may be calibrated using static or dynamic reflections. Static calibration uses the DC output (e.g., outputs 815) of the IQ demodulator in a reader's receiver, while dynamic calibration uses the AC output (e.g., outputs 817) of the IQ demodulator.

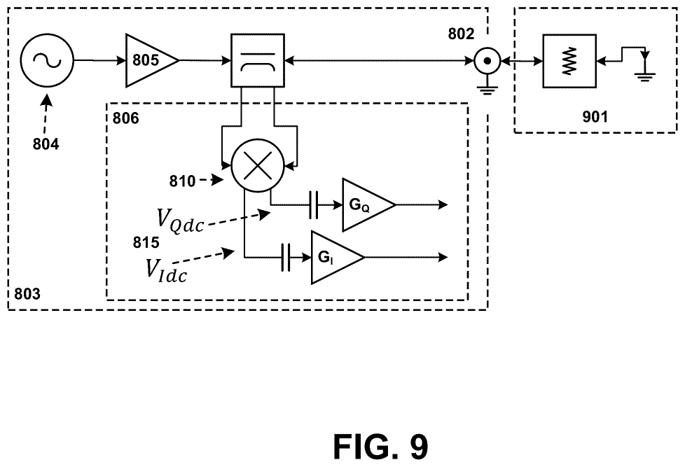

FIG. 9 depicts how an RFID reader transceiver such as reader transceiver 803 can be calibrated using a static reflection, according to embodiments. In FIG. 9, a load 901 with a non-zero reflection coefficient, such as an attenuator terminated by a short, is placed at the port 802 of reader transceiver 803. The transceiver 803 is first energized to operate at a first channel frequency, f_{c1}, provided by the frequency generator 804. While operating at the first channel frequency, the DC outputs 815 of the IQ demodulator 810 are measured to provide V_{Idc1} and V_{Qdc1} . Next, the frequency generator 804 is adjusted to provide a second channel frequency, f_{c2}. While operating at the second channel frequency, the DC outputs 815 of the IQ demodulator 810 are measured again to provide V_{Idc2} and V_{Qdc2} . If the two frequency channels are sufficiently near, f_{c1}≈f_{c2}, the reader transceiver delay, τ_{TxRx}, is:

$${τ}_{TxRx} ( \frac{{f}_{c 2} + {f}_{c 1}}{2} ) = \frac{{tan}^{- 1} \{ \frac{{V}_{Qdc 2}}{{V}_{Idc 2}} \} - {tan}^{- 1} \{ \frac{{V}_{Qdc 1}}{{V}_{Idc 1}} \}}{2 π ( {f}_{c 2} - {f}_{c 1} )}$$

where tan⁻¹(·) returns the inverse tangent in radians. This calibration assumes the load 901 does not have an inherent delay. If the load 901 does have an inherent delay, then it should be subtracted from the reader transceiver delay above to characterize the true reader transceiver delay. For example, if the load 901 is a long RF cable terminated with a shorted attenuator, the inherent delay caused by the long RF cable should be subtracted to characterize the true and correct reader transceiver delay.

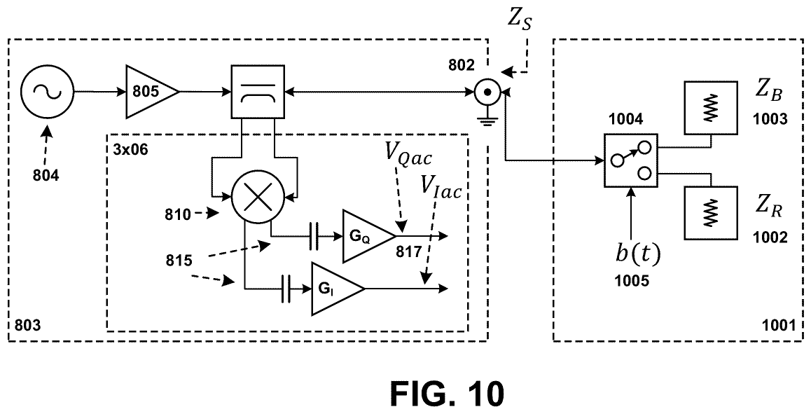

FIG. 10 depicts how an RFID reader transceiver such as reader transceiver 803 can be calibrated using a dynamic reflection, according to embodiments. In FIG. 10, a load 1001 is coupled to the port 802 of reader transceiver 803. In some embodiments, the load 1001 is configured to switch between two known complex impedances 1002 and 1003, having impedance values Z_{R} and Z_{B}, respectively. In these embodiments, the switching between the impedances occur over time via an electronic switch 1004 driven by a modulating signal 1005, b (t) If the source impedance looking into the port 802 is Z_{S}, then the dynamic reflection will cause a dynamic complex reflection coefficient, ΔΓ:

$$ΔΓ = \frac{{Z}_{R} - {Z}_{s}^{*}}{{Z}_{R} + {Z}_{S}} - \frac{{Z}_{B} - {Z}_{S}^{*}}{{Z}_{B} + {Z}_{S}}$$

where Z*_{S} represents the complex conjugate of Z_{S}.

During dynamic reflection calibration, the DC outputs 815 of the IQ demodulator 810 changes over time and accordingly may not be used for determining delay. Instead, the difference between the change of voltages on the I and Q outputs measured at the AC output 817 of the IQ demodulator 810 may be used.

In one embodiment, the transceiver 803 is first energized to operate at a first channel frequency, f_{c1}, provided by the frequency generator 804. At the first channel frequency, the load 1001 may cause voltage differences at the AC output 817, measured as V_{Iac1} and V_{Qac1} . The transceiver 803 may then be energized to operate at a second frequency channel, f_{c2}, provided by the frequency generator 804. While the transceiver 803 is operating at the second frequency channel, another pair of voltage differences at the AC outputs 817, V_{Iac2} and V_{Qac2} , are measured. The reader transceiver delay can then be calculated based on the two pairs of voltage differences:

$${τ}_{TxRx} ( \frac{{f}_{c 2} + {f}_{c 1}}{2} ) = \frac{{tan}^{- 1} \{ \frac{{V}_{Qac 2}}{{V}_{Iac 2}} \} - {tan}^{- 1} \{ \frac{{V}_{Qac 1}}{{V}_{Iac 1}} \}}{2 π ( {f}_{c 2} - {f}_{c 1} )} - \frac{arg \{ ΔΓ ( {f}_{c 2} ) \} - arg \{ ΔΓ ( {f}_{c 1} ) \}}{2 π ( {f}_{c 2} - {f}_{c 1} )}$$

where arg{·} returns the phase of a complex value in radians. The numerator of the second term, arg{ΔΓ(f c2)}−arg{ΔΓ(f_{c1})}, represents a phase delay caused by dynamic reflection. If dynamic has no delay, the phase of the complex reflection coefficient, arg{ΔΓ}, is constant over frequency, and if so, the equation for calibrating transceiver delay using a dynamic reflection with ‘AC’ voltage differences reduces to the equation for using a static reflection with absolute ‘DC’ voltages.

The reader system delay, τ_{rdr}, is a combination of components of the system;

including but not limited to the reader's transceiver, τ_{TxRx}, RF cables, τ_{cbl}, and antenna, τₐₙₜ:

τ_{rdr}(f)=τ_{TxRx}(f) τ_{cbl}(f) τₐₙₜ(f)

As described earlier, static or dynamic calibration can be applied to the reader's transceiver, but either calibration could be applied to the combination of components of the system. For example, attaching the dynamic reflection to the reader transceiver using the reader system's RF cable 821 would measure the delay for the transceiver-cable combination, τ_{TxRx-cbl}. If so, the total system delay would be:

τ_{rdr}(f)=τ_{TxRx-cbl}(f) τₐₙₜ(f)

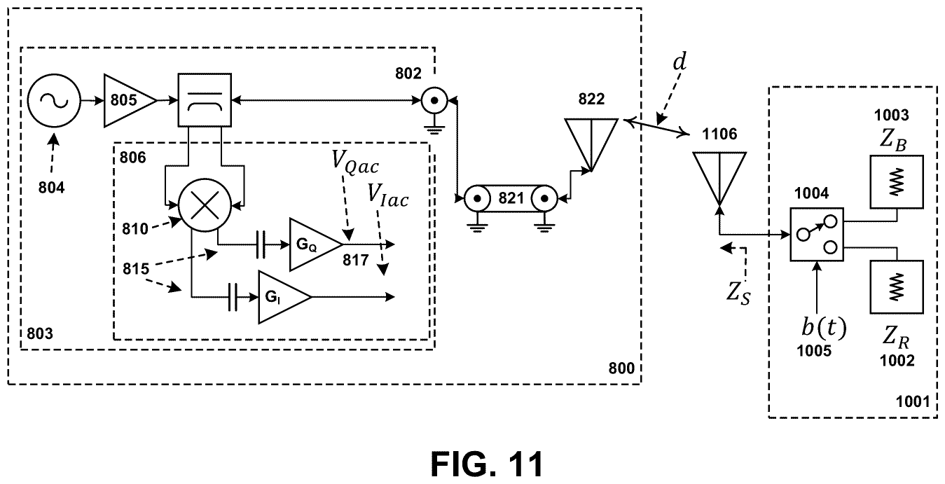

FIG. 11 depicts how an RFID reader system such as reader system 800 can be calibrated using a dynamic reflection in a radiated environment, according to embodiments. In FIG. 11, reader system 800 communicates with the load 1001, which is coupled to a reference antenna 1106 with a known phase center, known delay τ_{rdr}(f), and known impedance, Z_{S}. If the phase center of antenna 822 is separated from the phase center of reference antenna 1106 by d, the reader system delay can be calculated as:

$${τ}_{rdr} ( \frac{{f}_{c 2} + {f}_{c 1}}{2} ) = \frac{{tan}^{- 1} \{ \frac{{V}_{Qac 2}}{{V}_{Iac 2}} \} - {tan}^{- 1} \{ \frac{{V}_{Qac 1}}{{V}_{Iac 1}} \}}{2 π ( {f}_{c 2} - {f}_{c 1} )} - \frac{arg \{ ΔΓ ( {f}_{c 2} ) \} - arg \{ ΔΓ ( {f}_{c 1} ) \}}{2 π ( {f}_{c 2} - {f}_{c 1} )} - \frac{2 \cdot d}{c} - \frac{{τ}_{ref} ( f ) ,}{π ( {f}_{c 2} - {f}_{c 1} )}$$

where c is the radio wave propagation speed (e.g., the speed of light).

Once reader system delay has been determined using any of the techniques above or any other technique, the additive phase of the reader system, ϕₐᵣ(f) may then be determined:

ϕₐᵣ(f)=(2π·f τ_{rdr}(f))modulo(2π)

where the (x) modulo(y) operator returns the remainder of x divided by y.

After the reader system has been calibrated, the additive phase, ϕₐᵣ(f), or phase delay, τ_{rdr}(f), can be stored in an array or represented by a polynomial or represented by a linear equation. Post-calibration, modulation backscatter phase measurements can be compensated in the reader or host connected to the reader to provide a compensated phase measurement. The compensated phase measurement, ϕ_{c}, equals the difference between the phase measured by the reader system, ϕₘₑₐₛ, and the additive phase of the reader system:

ϕ_{c}(f)=ϕₘₑₐₛ(f)−ϕₐᵣ(f)

As mentioned above, RFID tags or tag systems may also contribute additive phase. For example, during a modulation backscatter process in which the tag is sending information back to a reader, the tag may add phase or phase delay. In this situation, the compensated phase measurement, ϕ_{c}, equals the phase measured by the reader system, ϕₘₑₐₛ, minus the additive phase of the reader system, ϕₐᵣ, and the additive phase of the tag system, ϕₐₜ:

ϕ_{c}(f)=ϕₘₑₐₛ(f)−ϕₐᵣ(f)−ϕₐₜ(f)

Additive phase in backscatter modulation from the tag can result from a delay of a tag antenna, impedance changes of the tag antenna, or impedances changes in an integrated circuit of the tag. Furthermore, additive phase can result indirectly from different frequencies of operation, from different power levels incident on the tag, or different materials near the tag.

Once the reader system additive phase and/or the tag system additive phase are known, methods for the compensation of phase measurements may be performed, for example, by the reader system or a host connected to the reader system.

One compensation method involves the measurement and creation of a table (or equation) for tag additive phase dependence on frequency, ϕₐₜ, and subsequent storage of the table or equation in a reader system or connected host. During operation, the reader system or host uses the frequency and one or more of the tables (or equations) to perform the phase measurement compensation. The table (or equation) used for compensation could be pre-determined, or the table could be dynamically selected based on information from the tag, such as an identifier. Other information that could be used in creating the tables (or equations) or in performing the phase compensation could include the types of material near the tag or incident power levels incident on the tag.

Another compensation method involves an RFID tag directly or indirectly providing information about the tag phase delay. A tag may directly provide information by sending tag additive phase data or values known to or stored on the tag. A tag may indirectly provide information by sending data associated with its operation or backscatter, such as its current impedance value or impedance setting, a radiated incident power level detected at the tag, or any other suitable parameter. A tag may also indirectly provide information via some characteristic of its backscattered reply, such as its incident power level at a receiving reader. This incident power level may be represented as a received signal strength indicator (RSSI). The RSSI of a tag reply is related to tag additive phase and varies with frequency. Accordingly, a reader may measure the RSSIs of replies from a tag at different frequencies and use the RSSIs to estimate tag additive phase. Upon receiving the information, a reader system or connected host can use the information for phase compensation.

These two methods to compensate for tag additive phase can be combined. For example, a table (or equation) of tag additive phase could include dependence on frequency, incident power level at the tag, and/or tag impedance, and a reader system or connected host can determine tag additive phase based on the table (or equation), incident power information conveyed from the tag, and/or tag impedance information conveyed from the tag.

One problem associated with phase-measurement-based tag range determination is that the periodic nature of phase means that a certain phase value can correspond to multiple ranges. This limitation is sometimes referred to as the “nπ modulo problem”. Some phase-measurement-based range determination techniques address this problem by limiting the system environment or parameters to ensure that any phase differences do not exceed a maximum value. In contrast, this disclosure addresses this problem by using a process that does not require such limits Specifically, instead of directly determining range or motion from phase measurements, multiple potential tag candidates are generated, each having a different range and/or motion. Using known data, such as the frequencies of reader-transmitted signals and values of additive reader system and tag system phase, a set of candidate phases is computed for each candidate. Then, the actual phase measurements of a real tag are compared and correlated to the candidate phases. If the actual phase candidate, then the range/motion of that candidate is determined to match the range/motion of the real tag.

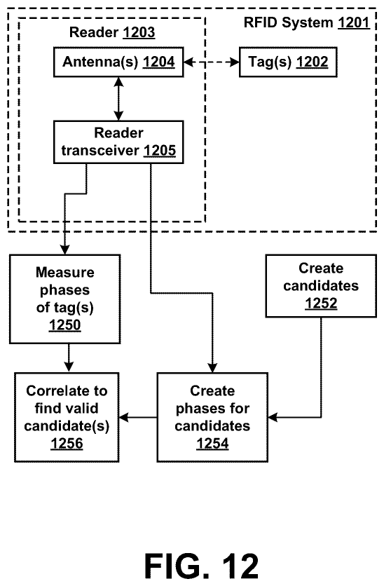

FIG. 12 depicts how RFID tag parameters such as range or motion can be determined by correlation to candidates, according to embodiments. FIG. 12 shows an RFID system 1201 including at least one tag 1202 and a reader system 1203. Reader system 1203 includes at least one antenna 1204 through which communications with tag 1202 occurs. Antenna 1204 is further coupled to reader transceiver 1205.

Using reader transceiver 1205, the reader system 1203 may communicate with tag 1202 to perform N+1 phase measurements at N+1 different frequencies (step 1250), resulting in a number of phase measurement/frequency pairs (ϕₙ, fₙ) for tag 1202. The phase measurements may either be unadjusted phases as measured by the reader system 1203, or may be compensated (as described above) phase values, for example to account for additive reader phase or tag phase.

To estimate tag location, the reader system 1203 or a connected host may generate a list of M tag candidates at step 1252. The tag candidates, or “virtual tags”, represent potential locations of an actual tag such as tag 1202, and are preferably each located at a different distance from the antenna 1204. A candidate at a distance dₘ will generate a phase in its response backscattered to the reader system 1203 that depends on the frequency of the backscattered (or carrier) signal and the distance dₘ. The N+1 different frequencies used in step 1250 can be used to compute N+1 phases for each candidate at step 1254, where a computed phase ψₘₙ for a given candidate m at a given frequency n depends on the candidate distance dₘ :

$${ψ}_{mn} = \frac{4 π {f}_{n}}{c} {d}_{m} for n = 0 … N$$

In the calculation, any constant phase offset between the phase measurements of actual tags to calculate phase differences can be removed by arbitrarily choosing a phase measurement, ϕ₀, as a reference phase generated by a reference frequency, f₀, to compute N phase differences, Δϕₙ, for the actual tag:

Δϕₙ=Δₙ−ϕ₀ for n=1 . . . N

In a similar manner, the phase difference for the m^{th} candidate, Δψₘₙ, can be computed using the same reference frequency:

$${Δψ}_{mn} = {ψ}_{mn} - {ψ}_{m 0} for n = 1 … N where {ψ}_{m 0} = \frac{4 π {f}_{0}}{c} {d}_{m}$$

In the above, the reference frequency, f₀, for the phase differences can be arbitrary, and the reference frequency is not limited to be either the lowest or highest frequency used in the phase measurements. In some embodiments, the quality of a phase measurement (described in more detail below) can be used to select the reference frequency, f₀, that is used determine the phase difference.

The candidate with a distance that is consistent with the actual tag location will have a high correlation. In step 1256, reader system 1203 or a host computes correlations for the M tag candidates, where the correlation for the m^{th} candidate is normalized by the number of measured phase differences, N, to determine the probability of the m^{th} candidate, pₘ:

$${p}_{m} = \frac{1}{N} \vert {\sum }_{n = 1}^{N} {e}^{j {Δϕ}_{n} - j {Δψ}_{mn}} \vert$$

After a number of phase measurements are taken, a candidate with a high correlation probability, pₘ≅1, may singularly emerge as a viable candidate, and this viable candidate will have a distance dₘ that approximates the distance of the actual tag (e.g., tag 1202) from the antenna (e.g., antenna 1204). If all candidates have low correlation probability, pₘ<<1 for m=1 . . . M, the low probability indicates no viable candidates and a low confidence in finding the distance of the actual tag.

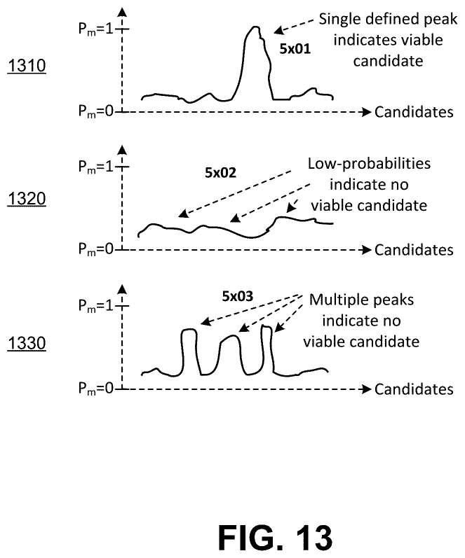

FIG. 13 depicts diagrams of how correlation may be used to determine RFID tag ranges, according to embodiments. Diagrams 1310, 1320, and 1330 are graphs of correlation probability curves for three different phase measurement scenarios. The vertical axis of the graphs represents correlation probability, and the horizontal axis represents tag candidate number ordered according to the tag candidate's distance from the reader system antenna. For example, a tag candidate that is closer to the antenna would be to the left of a tag candidate that is farther from the antenna.

Diagram 1310 depicts a correlation probability curve with one single defined peak that approaches a normalized value of one, pₘ≅1. This indicates that one viable candidate has been identified, and therefore that one candidate likely has an associated distance from the antenna approximately equal to the distance from the antenna of the actual tag.

Diagram 1320 depicts a correlation probability curve with low correlation probabilities that are significantly below a normalized value of one, indicating no viable candidates Similarly, diagram 1330 depicts a correlation probability curve with several significant correlation probabilities, also indicating no viable candidates.

In some embodiments, a candidate may be considered viable if it (a) corresponds to a significant peak in correlation probability and (b) it is the only such significant peak. For example, a candidate that corresponds to the only peak in a correlation probability curve may be considered viable if the height of its peak exceeds about a normalized value of 0.5 but may not be considered viable otherwise. If a correlation probability curve contains multiple significant peaks, all with similar heights (e.g., like in diagram 1330), then none of the peaks may correspond to viable candidates. On the other hand, if a correlation probability curve contains multiple significant peaks where one peak is significantly higher than the other peaks, then the candidate corresponding to that peak may be considered viable. In some embodiments, the significance of a peak can be measured based on the noise floor of the correlation probability. For example, diagram 1310 depicts a noise floor with a normalized value of approximately 0.2-0.25. A peak may be considered significant if it exceeds more than twice the noise floor, which in diagram 1310 would be a peak having a normalized value height of around 0.4-0.5.

The description has focused on one actual tag, but the method can be generalized for two or more actual tags since the reader associates phase measurements with individual tags; specifically, the reader provides the identity of the tag along with their phase measurement at a specific frequency.

In some embodiments, this method can also be generalized for two or more antennas on a reader system. For example, given a reader system of K antennas with Nₖ measured phase differences per antenna, the phase differences for the k^{th} antenna, Δϕₙₖ, can be readily determined by , the phase measurements, ϕₙₖ, from each antenna:

Δϕₙₖ=ϕₙₖ−ϕ₀ₖ for n=1 . . . Nₖ and k=1 . . . K

Similarly, the distance between the m^{th} candidate (virtual tag) and k^{th} antenna, dₘₖ, will determine the phase difference, Δψₘₙₖ:

$${Δψ}_{mnk} = {ψ}_{mnk} - {ψ}_{m 0 k} for n = 1 … {N}_{k} and k = 1 … K where {ψ}_{mnk} = \frac{4 π {f}_{n}}{c} {d}_{mn}$$

For candidates in two- or three-dimensional space, the distances between the candidate (virtual tag) and different antennas will often be different, for example dₘₖ≠dₘ₍ₖ₊₁₎. Some candidates may be symmetrically located between antennas, for example dₘₖ≠dₘ₍ₖ₊₁₎. The probability that the m^{th} candidate, pₘ, represents the position of the actual tag using K antennas is:

$${p}_{m} = \frac{1}{{N}_{tot}} \vert {\sum }_{k = 1}^{K} {\sum }_{n = 1}^{N} {e}^{j {Δϕ}_{nk} - j {Δψ}_{mnk}} \vert$$

where the total number of measured phase differences, Nₜₒₜ, equals the sum of measured phase differences over all antennas:

$${N}_{tot} = {\sum }_{k = 1}^{K} {N}_{k}$$

For a reader system with a single antenna, each candidate represents a surface in three-dimensional space, and if the phase center of the antenna is fixed, the candidate's surface is a sphere with radius dₘ from the phase center. For a reader system with first and second (two) antennas, the candidate represents a curve created by the intersection of two surfaces. If the phase centers of the two antennas are fixed, one sphere has a radius of dₘ₁ to the first phase center and the other sphere has radius dₘ₂ to the second phase center, and intersection of the spheres is an arc. And lastly, for a reader system with three or more antennas, the candidate represents a point in space created by the intersection of multiple sphere surfaces.

With no limitation on maximum phase difference, the choice of frequencies, fₙ, is unlimited, and in a frequency hopping or frequency agile RFID system, the channel frequencies and difference between channel frequencies is similarly unlimited. Additionally, this process eliminates the need for avoiding the “nit modulo problem” when placing the reader antennas, so the separation distance between two or more antennas is also not limited. And lastly, this process eliminates confining the tag location to avoid the “nit modulo problem”, so the tags can be in any arbitrary location.

In some embodiments, a “quality” or “validity” of the modulation backscatter measurements of the actual tag can be determined and used to augment the process to determine tag location. In these embodiments, each modulation backscatter phase measurement can be assigned a factor, qₙₖ, to denote the quality or validity of the nth phase measurement using the k^{th} antenna. For example, the factor could be a binary value based on a threshold where the backscatter power is above the threshold, qₙₖ=1, or below a threshold, qₙₖ=0. In another example, the factor could be proportional to the modulation backscatter power. The factor could also be based on data information from the actual tag. For example, the actual tag could relay data via modulation backscatter that its operating power is low, and if so, the quality of the modulation backscatter is similarly low, e.g., qₙₖ=0.

In some embodiments, another factor, Qₙₖ, can be defined to represent the quality or validity of the phase difference, Δϕₙₖ. The quality factor for the phase difference, Qₙₖ, can be defined independently or, for example, defined as the product of quality factors of phase measurements:

Qₙₖ=qₙₖ·q₀ₗ for n=1 . . . N

Regardless of the definition of the phase difference quality, Qₙₖ, a sum of the

quality of phase differences, Qₜₒₜ, can be defined:

$${Q}_{tot} = {\sum }_{k = 1}^{K} {\sum }_{n = 1}^{{N}_{k}} {Q}_{nk}$$

Accordingly, the normalized correlation using quality factor for each

candidate becomes:

$${p}_{m} = \frac{1}{{Q}_{tot} \cdot {N}_{tot}} \vert {\sum }_{k = 1}^{K} {\sum }_{n = 1}^{{N}_{k}} {Q}_{nk} {e}^{j Δ {ϕ}_{nk} - j Δ {ψ}_{mnk}} \vert$$

As described above, an RFID reader system can produce tag phase measurements using different antennas and different frequencies. If the tag or surrounding environment is in motion, the phase measurements will change over time, and these changes can be used to estimate tag motion. Assume a reader system has A+1 antennas in a monostatic configuration, and tag phase measurements are from the a th antenna, where a=0 . . . A. Further assume the phase measurements for one antenna are collected using Kₐ+1 frequencies, and the phase measurements are grouped by frequency, fₐₖ, where k=0 . . . Kₐ, for each antenna, a. And lastly, assume Nₐₖ+1 phase measurements are collected at each frequency and each antenna, where n=0 . . . Nₐₖ, at a specific time, tₐₖₙ. Collectively, all phase measurements from one tag, ϕₐₖₙ, frequency, are measured using the a^{th} antenna at a fₐₖ,. Each phase measurement is performed at a time instance, tₐₖₙ, and assume the time, t₀₀₀, of the first phase measurement, ϕ₀₀₀, is the earliest time, t₀₀₀≤tₐₖₙ.

Phase measurements, Δₐₖₙ, may sometimes be impaired by additive phase from the reader or from the tag that is caused by different power levels or by different frequencies. To minimize the impact of additive phase, phase differences may be taken between phase measurements from the same frequency and same antenna measured at different times:

Δϕₐₖₙᵣ=ϕₐₖₙ−ₐₖᵣ where n≠r

Arbitrarily choosing one of the phase measurements, ϕₐₖᵣ, as a reference defines a phase difference, Δϕₐₖₙᵣ. Phase differences using the same phase measurements, r=n, do not add insight since the phase difference is zero, Δϕₐₖₙₙ=0. In addition, phase differences using the same pair of phase measurements are redundant and do not add insight since they are opposite, Δϕₐₖₙᵣ=−Δϕₐₖᵣₙ. Phase differences from two (unique) phase measurements provide insight, and using “2 choose N”, the number of phase differences for each frequency on one antenna is:

$$( \begin{matrix}{N}_{ak} + 1 \\ 2\end{matrix} ) = \frac{( {N}_{ak} + 1 ) !}{2 ! ( {N}_{ak} + 1 - 2 ) !} = \frac{{N}_{ak} \cdot ( {N}_{ak} + 1 )}{2}$$

For example, four phase measurements, Nₐₖ+1=4, from one antenna, a, and one frequency, fₐₖ, produces six unique phase differences:

Δϕₐₖ₁₀, Δϕₐₖ₂₀, Δϕₐₖ₃₀, Δϕₐₖ₂₁, Δϕₐₖ₃₁, Δϕₐₖ₃₂

Using a spherical coordinate system based on the phase center of the a^{th} antenna, the propagation distance between a tag and the a^{th} antenna depends on the (scalar) radial distance, rₐ(f, t), between the tag and phase centers of the antenna and the tag. The phase centers of the tag and antenna depend on the frequency, f, of the RF wave while motion between the tag and antenna will depend on time, t. Non-overlapping antennas will have phase centers in different locations, so the radial distances between a tag and antennas will often, but not necessarily, differ.

Consider a population of virtual tags, herein referred to as candidates. For a quantity of M+1 candidates with m=0 . . . M, the propagation phase, ψₘₐ(f, t), between the m^{th} candidate and the a th antenna and depends on time, t, on frequency, f, and the radial distance between phase centers between the m^{th} candidate and the a^{th} antenna, rₘₐ (t, f):

$${ψ}_{ma} ( f , t ) = \frac{4 π f}{c} {r}_{ma} ( f , t )$$

where c is the speed of RF wave propagation.

If the motion of the m^{th} candidate is consistent with the motion of an (actual) tag, the candidate phases, ψₘₐ(f, t), will be consistent with phase measurements, ϕₐₖₙ, from the tag at different times, tₐₖₙ, and from different frequencies, fₐₖ. Comparing phase measurements, ϕₐₖₙ, and phases from candidates, ψₘₐ(f, t), may require reconciliation between temporal references between phase measurements and candidate phases. For instance, the radial distance between the m^{th} candidate and the a^{th} antenna, rₘₐ(f, t), may use a time reference, t, that differs from the reference used for phase measurement timestamps, tₐₖₙ. In addition, the radial distance may be only available at discrete times, τᵢ, and may be between two timestamps, e.g. tₐₖₙ<τᵢ<Tₐₖ₍ₙ₊₁₎.

For the moment, assume the time references are reconciled, and the candidate

phases share the same timestamps and frequencies as used in the phase measurements:

$${ψ}_{makn} ≡ {ψ}_{ma} ( {f}_{ak} , {t}_{akn} ) = \frac{4 π {f}_{ak}}{c} {r}_{ma} ( {f}_{ak} , {t}_{akn} )$$

A candidate has consistent motion with a tag when the candidate phases and the tag phases have a high probability of correlation. Suppose we have Nₐₖ+1 phase measurements from one antenna, a, using the k^{th} frequency, fₐₖ, then the normalized probability that the m^{th} candidate from one antenna and one frequency, pₘₐₖ, represents the motion of the tag is:

$${p}_{mak} = \frac{2}{{N}_{ak} \cdot ( {N}_{ak} + 1 )} \vert {\sum }_{r = 0}^{{N}_{ak} - 1} {\sum }_{n = r + 1}^{{N}_{ak}} {e}^{j ( {ϕ}_{akn} - {ϕ}_{akr} ) - j ( {ψ}_{makn} - {ψ}_{makr} )} \vert$$

Given the phase measurements of a tag over all frequencies from one antenna, pₘₐ, the combined normalized probability that the m^{th} candidate has consistent motion with the tag is:

$${p}_{ma} = {\sum }_{k = 0}^{{K}_{a}} {p}_{mak}$$

And lastly, given the phase measurements of a tag over all frequencies over all antennas, the combined normalized probability that the m^{th} candidate has consistent motion with the tag is:

$${p}_{m} = {\sum }_{a = 0}^{A} {p}_{ma} = {\sum }_{a = 0}^{A} {\sum }_{k = 0}^{K} {p}_{mak}$$

One probability per candidate, as in pₘ above, can be evaluated at one time, or the probabilities can be individually evaluated in more granular level, such as the probabilities at each antenna, pₘₐ.

For instance, suppose the phase measurements of a tag are from two antennas. Further suppose the direct propagation path between the tag and the first antenna is obscured and heavily dependent on multipath propagation, then the normalized probability of (all) candidates for the first antenna will be low. Now suppose the second antenna has a direct propagation path with the tag and the multipath propagation is small, then the normalized probability of one candidate from the second antenna will be high if the candidate represents the motion of the tag.

Computing the probability of one candidate will depend on several conditions. For fixed frequency operation, all the phase measurements on one antenna are performed at one frequency, K=0→k 32 0, and assume the number of phase measurements is 100, N₀₀=100. In this instance, the number of terms in the summation is the inverse of the normalization constant, ˜N₀₀²/2=5000. In frequency hopping mode, assume the phase measurements are approximately divided by approximately six frequencies, K+1=6, and each frequency has approximately 17 phase measurements, N₀ₖ+1=17≅100/6. During frequency hopping, the number of summation terms at each frequency equals the inverse of the normalization term for each frequency, N₀ₖ(N₀ₖ+1)/2 =136, so the total number of summation terms is approximately six times the amount for each frequency, (K+1)·Nₒₖ·(N₀ₖ1)/2. The number of summation terms for one candidate using fixed frequency (5000) or using frequency hopping (-816) can be reduced to decrease the computational requirements. For example, the phase measurements and their associated candidate phases can be initially down-sampled to use every other third phase measurement, N′₀ₖ=N₀ₖ/3, to reduce the summation terms by a factor of nine. The correlation with down-sampled phase measurements can provide a coarse indicator to what candidates are likely, and then a new correlation with all phase measurements can apply to likely candidates for full evaluation and higher accuracy.

The total number of summation terms to evaluate all candidates equals the number of candidates, M+1, multiplied by the summation terms per candidate. A similar strategy can be applied to the number of candidates to reduce computation requirements. To reduce computation, the number of candidates can be reduced by decreasing the spatial density of candidates (e.g., the number of candidates per unit volume) or reducing the physical region of where the candidates are located. Reducing the density of candidates provides a coarse indicator for likely candidates after a first correlation. Then based on the position of likely candidates, another set of candidates can be created at a higher density that are closely spaced and near the likely candidates, and a second correlation using the higher density candidates provides more accuracy with less computation.

If a-priori or in-situ knowledge of linear motion between the antennas and tag exists, a series of candidates can be constructed. Assume a volume of tags is moving along a line at constant speed, with the candidates in the volume. Using a 3D Cartesian coordinate system, assume the volume is a cuboid (rectangular solid) that travels along the X-axis at a constant speed, s. Without loss of generalization, assume that the origin of the coordinate system coincides with the center of the cuboid base when time is zero. With these assumptions, the vector representing the position of the m^{th} candidate is:

\vec{rₘ}(t)=(s·t+xₘ)\hat{x}+yₘŷ+zₘ\hat{z}

where the x, y, and z components of the m^{th} candidate are xₘ, yₘ, zₘ, respectively. Using the same coordinate system, a vector for the phase center of the a^{th} antenna that is fixed and independent of frequency can be defined:

\vec{rₐ}=Axₐ\hat{x}+Ayₐŷ+Ayₐ\hat{z}

where x, y, and z components of the phase center of the a^{th} antenna are Axₐ, Ayₐ, Azₐ, respectively. With the simplification that the phase center of the candidate is independent of frequency, the radial distance between the phase centers of the antenna and of a candidate in the cuboid is:

rₘₐ(f, t) =∥\vec{rₘ}(t)−\vec{rₐ}∥

where the ∥·∥ operator returns the (scalar) distance of a vector. Using Cartesian coordinates, the radial distance simplifies to:

rₘₐ(f, t)=\sqrt{[s·t+xₘ−Axₐ]²+[yₘ−Ayₐ]²+[zₘ−Azₐ]}

Multiple candidates may have the same radial distance for one antenna at the same instant of time. For example, suppose two candidates, m and \acute{m} where \acute{m}≠m, have the same x components, xₘ=x_{\acute{m}}, and reside in the same YZ plane with different y and z components, yₘ≠y_{\acute{m}} and zₘ≠z_{\acute{m}}. Two candidates in the same YZ plane will have the same radial distance if their y and z components have the same distance from the phase center of the antenna, (Ayₐ, Azₐ), in the YZ plane:

[yₘ−Ay₁]²+[zₘ−Az₁]²=[y_{\acute{m}}−Ay₁]²+[z_{\acute{m}}−Az₁]²

The (same) radial distance for these candidates cannot be resolved by one antenna, but two or more properly position antennas will remove this ambiguity. If two different antennas, a and á where á≠a, have different positions in the YZ plane, either Ayₐ≠Ay_{á} or Azₐ≠Az_{á}, candidates in the YZ plane can be resolved.

Two mirrored candidates, m and \acute{m} where \acute{m}≠m, may have the same y- and z-components, yₘ=y_{\acute{m}} and zₘ=z_{\acute{m}}, but travel in opposite directions, s=−ŝ, with initial x-components symmetrically placed from the antenna, xₘ−Axₐ=−x_{\acute{m}}+Axₐ. The two mirrored candidates will have the same radial distance for one antenna since the magnitude of the x-components are equal:

[s·t+xₘ−Axₐ]²=[−ś·t−(x_{\acute{m}}−Axₐ)]²

Two antennas in different YZ planes, Axₐ≠Ax_{á}, can resolve mirrored candidates. Furthermore, if the magnitude of the speed, s, has ambiguity, two antennas in different YZ planes will reduce the need for accurate knowledge of the speed. In general, with linear motion in 3D space, two or more antennas are ideally located at different positions along the axis of motion, Axₐ≠Ax_{á}, and their position should differ in the plane perpendicular to the axis of motion, either Ayₐ≠Ay_{á} or Azₐ≠Az_{á}.

Depending on computational resources and on (a priori or in-situ) knowledge of the object(s), the extent of the cuboid and density of candidates can be as large or small as needed. In general, more knowledge of the objects reduces the computational resources. For example, suppose the object is a box travelling on a (linear) conveyer belt system at a fixed speed along the x-axis, and the box has a depth, D, width, W, and height, H, that is positioned to respectively coincide with the x, y, and z directions. For convenience, assume that the coordinate system is arranged such that the bed of the conveyer system coincides with the XY plane. With this arrangement, candidates residing in the cuboid are limited in the z-axis from zero to the height of the box, 0≤zₘ≤H. If the width of the box and the coordinate system is centered with respect to the conveyer, candidates residing in the cuboid are limited to half the box width, |yₘ|<W/2. And lastly if the position of the center of the box relative to the depth, D_{c}, at the initial time, t=0, is known, candidates in the cuboid are limited to half the depth from the center, |xₘ−D_{c}|≤D/2. This collective knowledge of the box reduces the candidates in the cuboid for evaluation to:

$$\vert {x}_{m} - {D}_{c} \vert \leq \frac{D}{2}$$

$$\vert {y}_{m} \vert \leq \frac{W}{2}$$

$$0 \leq {z}_{m} \leq H$$

With more computational resources, the candidates and cuboid for evaluation can be expanded which may reduce the need for detailed object knowledge and/or limitations on object positions. For example, if the box was arbitrarily rotated so its depth and width were randomly oriented relative to the x- and y-axis, the cuboid of candidates should encompass any rotation of the box:

$$if {DW}_{max} = max \{ D , W \}$$

$$then$$

$$\vert {y}_{m} \vert \leq \frac{{DW}_{max}}{2}$$

$$and$$

$$\vert {y}_{m} - {D}_{c} \vert \leq \frac{{DW}_{max}}{2}$$

where max{·,·} operator provides the maximum of two values.

If the speed of the conveyer is unknown, then candidates can move at different speeds, sₘ:

rₘₐ(f, t)=\sqrt{[sₘ·t+xₘ−Axₐ]²+[yₘ−Ayₐ]²+[zₘ−Azₐ]}

With sufficient computation resources, candidates from multiple cuboids can be evaluated, or the cuboid could be a large volume that encompasses several boxes or even the entire length of the (straight) conveyer belt.

Some conveyer systems often slow, stop, or resume their motion, and if sufficient computational resources for candidates in these scenarios are unavailable, additional in-situ knowledge of the motion can reduce the computational resources needed for candidates. For instance, a sensor that monitors the speed or motion of the belt, herein referred to as belt sensor, can limit the candidates for evaluation. If the belt sensor provides a position on the belt, b(·), as a function of time, τ, as referenced to the sensor, then the radial distance for a candidate becomes:

rₘₐ(f, t)=\sqrt{[b(τ)+xₘ−Axₐ]²+[yₘ−Ayₐ]²+[zₘ−Azₐ]}

This radial distance using a belt sensor assumes the belt stretch is insignificant and assumes the box remains in a fixed position on the belt. In general, a belt sensor may have its own time reference for measurement, and if so, the time reference of the belt sensor needs to be synchronized with the time of phase measurements. Assume an offset time, τ_{off}, relates the time reference of the belt sensor, τ, and the time of the first phase measurement, t₀₀₀, from the first phase measurement, τ+τ_{off}=t₀₀₀. The belt sensor may provide (non-continuous) discrete values of belt position at different time instances. Assume the belt sensor provides two discrete samples of belt position, b(τᵢ) and b(τᵢ₊ᵢ), at adjacent time instances, τᵢ and τᵢ₊₁, and assume the two samples bound a phase measurement, tₐₖₙ:

τᵢ+τ_{off}≤τₐₖₙ≤τᵢ₊₁+τ_{off}

If the two samples of belt position are sufficiently close where the speed of motion is nearly constant, linear interpolation between the belt position will yield a representative radial distance:

$${r}_{ma} ( f , {t}_{akn} ) = \sqrt{{[ \frac{b ( {τ}_{i} + {τ}_{off} ) + b ( {τ}_{i + 1} + {τ}_{off} )}{2} + {x}_{m} - {Ax}_{a} ]}^{2} + {[ {y}_{m} - {Ay}_{a} ]}^{2} + {[ {z}_{m} - {Az}_{a} ]}^{2}}$$

This radial distance derived from a belt sensor can be used to determine the phase of candidates for evaluation, repeated here for clarity:

$${ψ}_{makn} ≡ {ψ}_{ma} ( {f}_{ak} , {t}_{akn} ) = \frac{2 π {f}_{ak}}{c} {r}_{ma} ( {f}_{ak} , {t}_{akn} )$$

Evaluating candidates in 3D space for arbitrary (non-linear) motion can be performed with a-priori knowledge of the motion or in-situ knowledge of motion with an actuator or a sensor. For instance, a lidar sensor or dual-camera sensor can provide vector information about the motion of an object(s), \vec{R}(Σ), over time that can be decomposed into different vector components:

\vec{R}(Σ)=Rx(τ)\hat{x}+Ry(τ)ŷ+Rz(τ)\hat{z}

Assuming candidates move with the object and share the same trajectory:

\vec{rₘ}(τ)=\vec{R}(τ)+xₘ\hat{x}+eₘŷ+zₘ\hat{z}

Then radial distance between the (stationary) antenna and candidate will be:

rₘₐ(f,t)=∥\vec{rₘ}(τ)−\vec{rₐ}∥

And the radial distance becomes:

$${r}_{ma} ( f , τ ) = ( \sqrt{{[ Rx ( τ ) + {x}_{m} - {Ax}_{a} ]}^{2} + {[ Ry ( τ ) + {y}_{m} - {Ay}_{a} ]}^{2} + {[ Rz ( τ ) + {z}_{m} - {Az}_{a} ]}^{2}}$$

Some sensors provide information about the object size and orientation, and if so, this information can be used to refine the candidate positions. Suppose an object translates in space and rotates about the z-axis over time with a rotation provided by the sensor, ι(τ). In this case, the candidates are better represented by the radius, ρₘ , and angle, θₘ, in the XY plane that translates with object motion:

\vec{rₘ}(τ)=\vec{R}(τ)+Σₘ cos(Σ(τ)+θₘ)\hat{x}+ρₘ sin(Θ(τ)+θₘ)ŷ+xₘ\hat{z}

Then the radial distance between an antenna and candidate becomes:

$${r}_{ma} ( f , τ ) = \sqrt{\begin{matrix}{[ Rx ( τ ) + {ρ}_{m} cos ( Θ ( τ ) + {θ}_{m} ) - {Ax}_{a} ]}^{2} + \\ {[ Ry ( τ ) + {ρ}_{m} sin ( Θ ( τ ) + {θ}_{m} ) - {Ay}_{a} ]}^{2} + \\ {[ Rz ( τ ) + {z}_{m} - {Az}_{a} ]}^{2}\end{matrix}}$$

This last example of creating candidates based on object translation and object rotation illustrates that objects have six degrees of freedom; three for position and three for orientation. Many, but not all, environments have one or more of the degrees limited, and if so, the number of candidates and associated computational requirements can be reduced.

These examples are for stationary antennas and moving objects and tags. However, the correlation and evaluation of the probability for different candidates can accommodate moving antennas and stationary tags as well as moving antennas and moving tags. Knowledge of object or antenna motion from sensors or actuators provide information to create candidates and determine the radial distances between antennas and candidates. With radial distances for candidates, the phase of candidates can be evaluated for consistency with phase measurements of a tag, and if a candidate has high correlation with phase measurements, the candidate represents the tag motion or location.

To measure phases at different signal frequencies, an RFID system can transmit a signal with substantial power at multiple frequencies (e.g., a chirp or a broadband signal). When a tag replies by backscattering the signal, the backscattered signal will include signal components at the multiple frequencies. The RFID system can then use the phases of those signal components with respect to the originally transmitted signal to estimate tag parameters such as range and motion, as described above. An RFID system can also measure phases at different signal frequencies by inventorying a tag multiple times at different carrier frequencies. For example, the RFID system may inventory a tag in multiple successive inventory rounds, each using a different carrier frequency, then determine phases for the tag in the multiple inventory rounds.

In some cases, spectral use regulations restricting the frequency range and power of transmitted signals reduces the number of different frequencies that can be simultaneously used in a single signal, thereby reducing the accuracy of ranging based on phase comparison. Further, a reader may not be able to inventory the same tag more than once, especially if the tag is moving or if there are a lot of other tags present.

One way to address these challenges may be for a reader to change the carrier frequency within a single inventory round. This fast frequency switching, if done appropriately, allows phases to be measured at multiple signal frequencies without running afoul of spectral use regulations or having to inventory the tag more than once.

Carrier frequency switching can introduce high-frequency noise (sometimes known as frequency/spectral splatter or switch noise) into the carrier waveform, and accordingly should be timed judiciously in order to avoid degrading the RF environment and/or violating spectral use regulations.

In some embodiments, a reader transmitting an RF waveform can be configured to switch frequencies when the amplitude of the RF waveform is relatively low, to assure that any switching-generated noise also has relatively low amplitude. An RF waveform may have low amplitude at certain times regardless of how (or even if) it is modulated. For example, an RF waveform centered near zero amplitude will always have low amplitude at or near zero crossings, where the RF waveform transitions between positive and negative amplitudes.

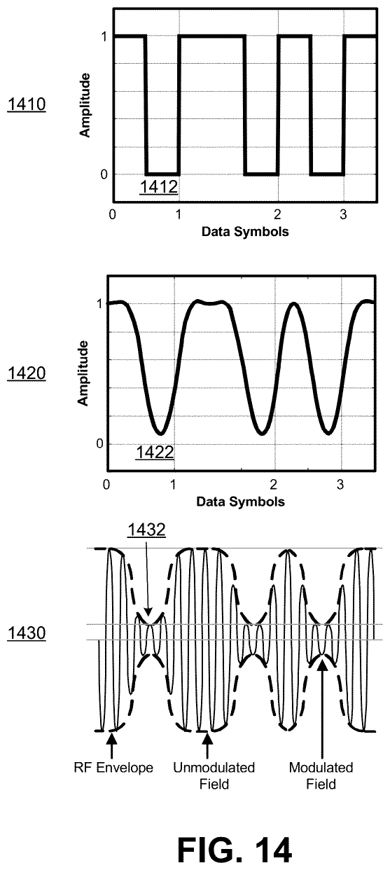

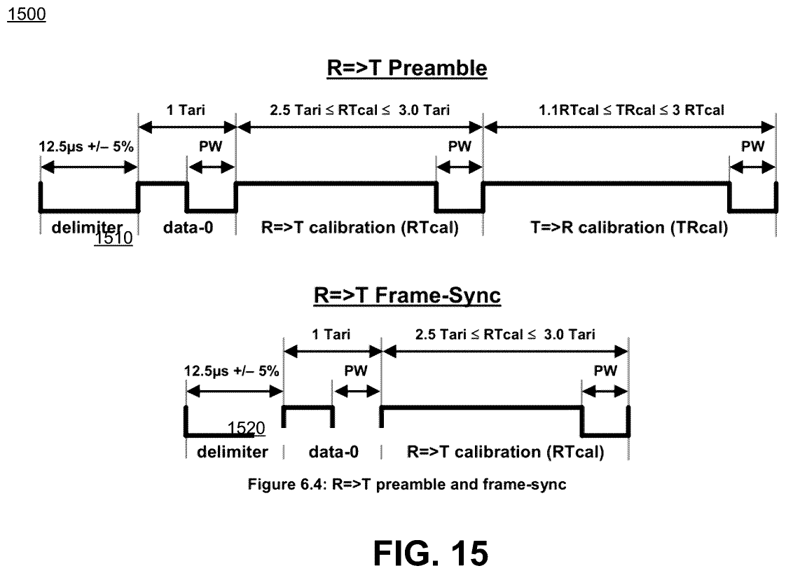

An amplitude-modulated RF waveform additionally may have low amplitude based on how the waveform is modulated. FIG. 14 depicts example baseband, modulating, and modulated waveforms at an RFID reader, and are similar to the waveforms in Annex H of the Gen2 Protocol. Waveform 1410 is an example sequence of three data symbols 0, 1, and 0 as described in section 6.3.1.2.3 of the Gen2 Protocol. The data symbols in waveform 1410 encode data in the form of time duration at a particular amplitude (e.g., the amplitude “1”) before transitioning to a different amplitude (e.g., the amplitude “0”). Accordingly, each data symbol includes at least one relatively high amplitude portion and at least one relatively low amplitude portion. For example, the first data symbol depicted in waveform 1410 includes a low-amplitude portion 1412. The example sequence in waveform 1410 can then be converted into a double-sideband (DSB) or single-sideband (SSB) amplitude-shift keying (ASK) modulating waveform 1420. In modulating waveform 1420, low-amplitude portion 1412 in waveform 1410 has been converted to low-amplitude portion 1422. Subsequently, modulating waveform 1420 can be used to amplitude-modulate an RF carrier waveform to generate modulated waveform 1430, which can be transmitted to RFID tags. Specifically, modulated waveform 1430 is formed by using modulating waveform 1420 to shape the RF envelope of an RF carrier waveform such that the RF envelope of the resulting, modulated waveform 1430 resembles modulating waveform 1420. In the modulated waveform 1430, portions corresponding to high-amplitude portions of modulating waveform 1420 may be relatively unmodulated and maintain a relatively high amplitude, similar to the amplitude of the unmodulated carrier waveform. In contrast, portions of modulated waveform 1430 corresponding to low-amplitude portions of modulating waveform 1420 may be significantly modulated to have a relatively low amplitude. For example, portion 1432 of the modulated waveform 1430 corresponds to low-amplitude portion 1422 of the modulating waveform 1420, and therefore has a relatively low amplitude.

The difference between high and low amplitudes in an amplitude-modulated RF waveform may be characterized by “modulation depth”, which is a ratio of (1) the difference between the amplitude of the unmodulated portions (corresponding to high amplitude) and the amplitude of the modulated portions (corresponding to low amplitude) to (2) the amplitude of the unmodulated portions. For example, a modulated waveform having a modulation depth of 50% includes modulated portions that have half the amplitude of unmodulated portions. A modulated waveform having a modulation depth of 90% includes modulated portions that have a tenth of the amplitude of unmodulated portions. In general, modulation depths tend to be between 30% and 100%, inclusive, although other suitable modulation depths can be used.

Regardless of whether a reader-transmitted RF waveform has low amplitudes due to zero crossings or modulation, a reader may opt to switch frequencies during these low amplitude portions, without interrupting the waveform transmission. The reader may know when the low amplitude portions will occur and may time its frequency switching accordingly. For example, the reader may identify low amplitude portions within data or a command that it will transmit and may perform a frequency transition while transmitting the data or command

In some embodiments, the reader may identify or predict when low-amplitude portions or pulses will occur based on knowledge of the data to be transmitted and perform frequency transitions during those portions or pulses. For example, the reader may identify a low-amplitude portion or pulse within a command that it will transmit and may perform a frequency transition while transmitting the command In this case, the reader may ensure that the average power of the RF waveform containing the entire command is sufficient for a tag to receive the command or otherwise operate without powering-down during the frequency transition. After sending the RF waveform amplitude-modulated with the command, the reader may transmit the RF waveform with no modulation to provide power for a receiving tag to complete processing the command and send a tag response, if any, backscatter-modulated onto the unmodulated RF waveform. Performing frequency switching when a transmitted, amplitude-modulated RF waveform has a relatively low amplitude reduces the amplitude of any noise components generated due to the switching.

In some embodiments, a reader may switch frequencies during transmission of a Gen2 delimiter symbol. FIG. 15 depicts delimiter symbols according to the Gen2 Protocol. Diagram 1500 depicts a reader-to-tag preamble and frame-sync, as described and depicted in section 6.3.1.2.8 and FIG. 6.4 of the Gen2 Protocol, respectively. The preamble and frame-sync each include a delimiter 1510 and 1520, respectively, having relatively low amplitude for a time duration of approximately 12.5 μs. In some embodiments, the reader may determine or predict when a delimiter is scheduled to be transmitted, based on knowledge of any responses to be transmitted, and perform frequency transitions during the delimiter. Of course, in other embodiments a reader may switch frequencies during transmission of any low- amplitude symbol or amplitude-modulated waveform portion, as long as the symbol or portion duration is compatible with commands and signaling in the appropriate command signaling scheme (e.g., the Gen2 Protocol).

A reader may not necessarily switch frequencies only at low-amplitude portions of or pulses in a transmitted amplitude-modulated RF waveform. Instead, a reader may be able to identify and switch frequencies at other portions of or pulses in the RF waveform with amplitude and duration suitable for frequency switching. In some embodiments, the reader may be determine its frequency-switching behavior such that the resulting spectral characteristic (the waveform frequency distribution or characteristic) satisfies a threshold. For example, the reader may configure its frequency-switching behavior such that the resulting spectral characteristic satisfies a transmit mask, such as the transmit masks depicted in FIGS. 6.6 and 6.7 of the Gen2 Specification. The reader may instead configure its frequency-switching such that the resulting spectral characteristic does not interfere with nearby RF systems. In the latter situation, the reader or a controller associated with the reader may be configured to determine an appropriate spectral characteristic and adjust the reader's frequency-switching behavior appropriately.

A reader system may default to fast frequency switching behavior or may only perform fast frequency switching in certain circumstances. In some embodiments, when a reader determines that it is to perform a frequency hop, it may determine whether any tags that it has communicated with recently will require power during the frequency hop. For example, the reader may determine that a tag is performing some lengthy or power-intensive operation, that a tag stores or maintains some state information that would be lost if power is interrupted, and/or that a tag is performing some other operation that cannot be reversibly interrupted. If the reader determines that one or more tags will require power during the frequency hop, then the reader may perform fast frequency switching. On the other hand, if the reader determines that no tags will require power during the frequency hop, then the reader may not perform fast frequency switching. In some embodiments, a reader may be configured to always perform fast frequency switching.

An RFID reader system can perform fast frequency switching in any suitable way. For example, the RFID reader system may simultaneously generate multiple carrier frequencies for fast switching. Commonly-assigned U.S. Pat. No. 10,679,019, issued on Jun. 9, 2020 and the entirety of which is hereby incorporated by reference, describes several ways by which an RFID reader system can simultaneously generate multiple carrier frequencies. In one implementation, an RFID reader system may include multiple frequency synthesizers, each configured to generate a different frequency. If two or more of the synthesizers are simultaneously generating different frequencies, the reader can switch its transmitted carrier frequency between the different frequencies without waiting for oscillator settling. In another implementation, an RFID reader system can generate a broadband signal, use a comb filter to recover desired frequency components from the broadband signal, then select a suitable or desired carrier frequency from the recovered frequency components. In another example, an RFID reader system can use a digital frequency synthesizer (DFS) to sequentially generate different carrier frequencies for fast frequency switching.

In general, more replies from a tag result in more phase measurement opportunities, which may help to refine tag parameter determination. In some embodiments, techniques for eliciting multiple replies from an RFID tag within a single inventory round can be used, in addition to the fast frequency switching behavior described above. In these embodiments, a reader or reader system may be configured to measure the phases of multiple replies from a single tag within the same inventory round. Phase measurements of multiple replies from a moving RFID tag within a single inventory round bypass the nit modulo problem, as long as the RFID tag is not moving fast enough to allow a single phase value to correspond to multiple ranges. In one embodiment, a reader system may cause a tag to reply multiple times with its identifier. According to the Gen2 Protocol, when a reader sends an ACK command to a tag in an inventory round, the tag may backscatter a reply including an electronic product code (EPC). In some embodiments, the reader can send an ACK, receive a tag reply containing an EPC, then send another ACK and receive another tag reply containing the EPC. In this way, the reader is assured of receiving at least two tag replies from which it can measure phase. Moreover, because the tag replies contain the same data, the phase measurements for the tag replies may be more easily compared versus a situation in which phase measurements are associated with tag replies having different content. In these embodiments, the reader may switch carrier frequencies between transmitting the two ACKs, such that the two phase measurements are at different frequencies, or may not switch carrier frequencies, especially if the tag is moving relatively quickly. While in the above a reader causes a tag to reply multiple times using ACK commands, any suitable command that causes a tag to reply multiple times within an inventory round, with the same data or not, may be used.

In other embodiments, a reader system may be configured to perform multiple phase measurements while receiving a single tag reply, especially when the tag is likely to be moving quickly. The quick tag movement may result in significant differences in measured phase within the same tag reply, even at the same frequency. The reader system may be configured to choose an interval between successive phase measurements, based on preset timing or some knowledge of the tag. For example, if the reader system knows that a certain tag is likely to be moving with a certain velocity (e.g., based on sensor information as described above), then the reader system may select an interval between successive phase measurements suitable for that velocity.

According to some examples, a method for an RFID system to estimate a location of an RFID tag may include transmitting, sequentially within a single inventory round, a first RF signal having a first frequency and a second RF signal having a second frequency; receiving from the RFID tag, within the single inventory round, a first reply backscatter-modulated on the first RF signal and a second reply backscatter-modulated on the second RF signal; determining a first set of phase differences associated with the first reply and the second reply; attempting to correlate the first set of phase differences to a at least a first plurality of candidates, where each candidate is associated with a respective location; and estimating, based on the attempted correlation, a first location of the RFID tag.

According to other examples, the first reply and the second reply may be in response to successive commands from an RFID reader. The successive commands may be ACK commands according to the Gen2 Protocol. The first reply and the second reply may include the same content. The first RF signal and the second RF signal may be transmitted by a single reader employing fast frequency switching. Determining the first set of phase differences may include determining an initial set of phase differences; and removing at least one of an additive reader phase and an additive tag phase from the initial set of phase differences to generate the first set of phase differences.

According to further examples, attempting to correlate the first set of phase differences to at least the first plurality of candidates may include attempting to determine whether a single candidate has a significant correlation probability. Estimating the first location of the RFID tag may include if only the single candidate has the significant correlation probability, then estimating the location associated with the single candidate as the first location of the RFID tag, otherwise estimating that the first location of the RFID tag is inconclusive. The method may further include transmitting, sequentially within another inventory round, a third RF signal having a third frequency and a fourth RF signal having a fourth frequency; receiving from the RFID tag, within the other inventory round, a third reply backscatter-modulated on the third RF signal and a fourth reply backscatter-modulated on the fourth RF signal; determining a second set of phase differences associated with the third reply and the fourth reply; attempting to correlate the second set of phase differences to at least a second plurality of candidates, where each candidate is associated with a respective location; estimating, based on the attempted correlation of the second set of phase differences, a second location of the RFID tag; and estimating, based on at least the first location and the second location, a movement of the RFID tag. Receiving the first and second replies may include receiving the first and second replies at each of a first antenna and a second antenna; and the first set of phase differences may include phase differences of the first and second replies with regard to the first antenna and phase differences of the first and second replies with regard to the second antenna.

According to some examples, a method for an RFID system to estimate a velocity of an RFID tag may include transmitting, within a first inventory round, a first set of successive RF signals, where each RF signal in the first set of RF signals has a different frequency; receiving a first set of replies from the RFID tag during the first inventory round, where at least two replies in the first set of replies are backscatter-modulated on two distinct RF signals of the first set of RF signals; transmitting, within a second inventory round, a second set of successive RF signals, where each RF signal in the second set of RF signals has a different frequency; receiving a second set of replies from the RFID tag during the second inventory round, where at least two replies in the second set of replies are backscatter- modulated on two distinct RF signals of the second set of RF signals; determining a first set of phase differences associated with the first set of replies; determining a second set of phase differences associated with the second set of replies; attempting to correlate the first set of phase differences and the second set of phase differences to a plurality of candidates, where each candidate is associated with a respective velocity; and estimating, based on the attempted correlation, the velocity of the RFID tag.

According to other examples, the first set of replies and the second set of replies may be in response to successive commands from an RFID reader. The successive commands may be ACK commands according to the Gen2 Protocol. The first set of replies and the second set of replies may include the same content. The first set of RF signals and the second set of RF signals may be transmitted by a single reader employing fast frequency switching. Determining the first set of phase differences may include determining a first initial set of phase differences; and removing at least one of an additive reader phase and an additive tag phase from the first initial set of phase differences to generate the first set of phase differences. Determining the second set of phase differences may include determining a second initial set of phase differences; and removing at least one of an additive reader phase and an additive tag phase from the second initial set of phase differences to generate the second set of phase differences.

According to further examples, attempting to correlate the first set of phase differences and the second set of phase differences to the plurality of candidates may include attempting to determine whether a single candidate has a significant correlation probability. Estimating the velocity of the RFID tag may include if only the single candidate has the significant correlation probability, then estimating a velocity associated with the single candidate as the velocity of the RFID tag, otherwise estimating that the velocity of the RFID tag is inconclusive. Receiving the first set of replies and the second set of replies may include receiving the first set of replies and the second set of replies at each of a first antenna and a second antenna. The first set of phase differences may include phase differences of the first set of replies and the second set of replies with regard to the first antenna and phase differences of the first set of replies and the second set of replies with regard to the second antenna.

According to some examples, a method for an RFID system to estimate a velocity of an RFID tag may include transmitting, within a single inventory round, two identical commands; receiving from the RFID tag, within the single inventory round, a first reply to one of the two commands and a second reply to the other of the two commands; determining a first set of phase differences associated with the first reply and the second reply; attempting to correlate the first set of phase differences to a first plurality of candidates; and estimating, based on the attempted correlation, the velocity of the RFID tag.

According to other examples, a method for an RFID system to estimate a location of an RFID tag may include transmitting, sequentially, within a single inventory round, a first modulated RF signal having a first frequency and a second modulated RF signal having a second frequency, where a transition between transmitting the first modulated RF signal and transmitting the second modulated RF signal occurs at a low-amplitude pulse in the first RF signal; receiving from the RFID tag, within the single inventory round, a first reply backscatter-modulated on the first modulated RF signal and a second reply backscatter-modulated on the second modulated RF signal; determining a first set of phase differences associated with the first reply and the second reply; and estimating, based on the first set of phase differences, the location of the RFID tag.

According to yet other examples, attempting to correlate the first set of phase differences may include using at least one quality parameter to perform the correlation. The quality parameter may include a quality of a backscatter measurement and a quality of a phase difference. The first plurality of candidates may include a first set of candidates associated with the first antenna and a second set of candidates associated with the second antenna. The first plurality of candidates may be generated based on data from a sensor, where the sensor may include at least one of a belt sensor, a lidar sensor, and a dual-camera sensor. Attempting to correlate the first set of phase differences to at least a first plurality of candidates may include attempting to correlate the first set of phase differences to the first plurality of candidates to determine a set of likely candidates; generating a second plurality of candidates based on locations of the set of likely candidates, where each candidate in the second plurality is associated with a respective location and the second plurality of candidates has a higher spatial density than the first plurality of candidates; attempting to correlate the first set of phase differences to the second plurality of candidates; and estimating, based on the attempted correlation to the second plurality of candidates, the first location of the RFID tag.

As mentioned previously, embodiments are directed to using phase to determine RFID tag parameters. Embodiments additionally include programs, and methods of operation of the programs. A program is generally defined as a group of steps or operations leading to a desired result, due to the nature of the elements in the steps and their sequence. A program is usually advantageously implemented as a sequence of steps or operations for a processor, but may be implemented in other processing elements such as FPGAs, DSPs, or other devices as described above.

Performing the steps, instructions, or operations of a program requires manipulating physical quantities. Usually, though not necessarily, these quantities may be transferred, combined, compared, and otherwise manipulated or processed according to the steps or instructions, and they may also be stored in a computer-readable medium. These quantities include, for example, electrical, magnetic, and electromagnetic charges or particles, states of matter, and in the more general case can include the states of any physical devices or elements. Information represented by the states of these quantities may be referred-to as bits, data bits, samples, values, symbols, characters, terms, numbers, or the like. However, these and similar terms are associated with and merely convenient labels applied to the appropriate physical quantities, individually or in groups.

Embodiments furthermore include storage media. Such media, individually or in combination with others, have stored thereon instructions, data, keys, signatures, and other data of a program made according to the embodiments. A storage medium according to embodiments is a computer-readable medium, such as a memory, and can be read by a processor of the type mentioned above. If a memory, it can be implemented in any of the ways and using any of the technologies described above.

Even though it is said that a program may be stored in a computer-readable medium, it does not need to be a single memory, or even a single machine. Various portions, modules or features of it may reside in separate memories, or even separate machines. The separate machines may be connected directly, or through a network such as a local access network (LAN) or a global network such as the Internet.

Often, for the sake of convenience only, it is desirable to implement and describe a program as software. The software can be unitary, or thought of in terms of various interconnected distinct software modules.

The foregoing detailed description has set forth various embodiments of the devices and/or processes via the use of block diagrams and/or examples. Insofar as such block diagrams and/or examples contain one or more functions and/or aspects, each function and/or aspect within such block diagrams or examples may be implemented individually and/or collectively, by a wide range of hardware, software, firmware, or virtually any combination thereof. Some aspects of the embodiments disclosed herein, in whole or in part, may be equivalently implemented employing integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, configurations, tags, RFICs, readers, systems, and the like, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). Any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. All language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells Similarly, a group having 1-5 cells refers to groups having 1, 2, 3, 4, or 5 cells, and so forth.

1. A method for a radio frequency identification (RFIDA system to estimate a location of an RFID tag, the method comprising:
transmitting, sequentially within a single inventory round, a first RF signal having a first frequency and a second RF signal having a second frequency;
receiving from the RFID tag, within the single inventory round, a first reply backscatter-modulated on the first RF signal and a second reply backscatter-modulated on the second RF signal;
determining a first set of phase differences associated with the first reply and the second reply;
attempting to correlate the first set of phase differences to a at least a first plurality of candidates, wherein each candidate is associated with a respective candidate location; and
estimating, based on the attempted correlation, a first location of the RFID tag.

2. The method of claim 1, wherein the first reply and the second reply are in response to successive commands from an RFID reader.

3. The method of claim 2, wherein the successive commands are ACK commands according to the Gen2 Protocol.

4. The method of claim 1, wherein the first reply and the second reply include the same data.

5. The method of claim 1, wherein the first RF signal and the second RF signal are transmitted by a single reader employing fast frequency switching.

6. The method of claim 1, wherein determining the first set of phase differences comprises:
determining an initial set of phase differences; and
removing at least one of an additive reader phase and an additive tag phase from the initial set of phase differences to generate the first set of phase differences.

7. The method of claim 1, wherein:
attempting to correlate the first set of phase differences to at least the first plurality of candidates comprises attempting to determine whether a single candidate has a significant correlation probability; and
estimating the first location of the RFID tag comprises:
if only the single candidate has the significant correlation probability, then estimating the location associated with the single candidate as the first location of the RFID tag.

8. The method of claim 1, further comprising:
transmitting, sequentially within another inventory round, a third RF signal having a third frequency and a fourth RF signal having a fourth frequency;
receiving from the RFID tag, within the other inventory round, a third reply backscatter-modulated on the third RF signal and a fourth reply backscatter-modulated on the fourth RF signal;
determining a second set of phase differences associated with the third reply and the fourth reply;
attempting to correlate the second set of phase differences to at least a second plurality of candidates, wherein each candidate in the second plurality of candidates is associated with a respective location;
estimating, based on the attempted correlation of the second set of phase differences, a second location of the RFID tag; and
estimating, based on at least the first location and the second location, a movement of the RFID tag.

9. The method of claim 1, wherein:
receiving the first reply and the second reply comprises receiving the first reply and the second reply at each of a first antenna and a second antenna; and
the first set of phase differences comprises phase differences of the first reply and the second reply with regard to the first antenna and phase differences of the first reply and the second reply with regard to the second antenna.

10. A method for a radio frequency identification (RFIDA system to estimate a velocity of an RFID tag, the method comprising:
transmitting, within a first inventory round, a first set of successive RF signals, wherein each RF signal in the first set of RF signals has a different frequency;
receiving a first set of replies from the RFID tag during the first inventory round, wherein at least two replies in the first set of replies are each backscatter-modulated on a different RF signal in the first set of RF signals;
transmitting, within a second inventory round, a second set of successive RF signals, wherein each RF signal in the second set of RF signals has a different frequency;
receiving a second set of replies from the RFID tag during the second inventory round, wherein at least two replies in the second set of replies are each backscatter-modulated on a different RF signal in the second set of RF signals;
determining a first set of phase differences associated with the first set of replies;
determining a second set of phase differences associated with the second set of replies;
attempting to correlate the first set of phase differences and the second set of phase differences to a plurality of candidates, wherein each candidate is associated with a respective candidate velocity of the RFID tag; and
estimating, based on the attempted correlation, the velocity of the RFID tag.

11. A method for a radio frequency identification (RFID) system to estimate a location of an RFID reader antenna, the method comprising:
transmitting, sequentially within a single inventory round, a first RF signal having a first frequency and a second RF signal having a second frequency;
receiving from an RFID tag, within the single inventory round, a first reply backscatter-modulated on the first RF signal and a second reply backscatter-modulated on the second RF signal;
determining a first set of phase differences associated with the first reply and the second reply;
attempting to correlate the first set of phase differences to a at least a first plurality of candidates, wherein each candidate is associated with a respective location; and
estimating, based on the attempted correlation, a first location of the RFID reader antenna.

12. The method of claim 11, further comprising:
transmitting, sequentially within another inventory round, a third RF signal having a third frequency and a fourth RF signal having a fourth frequency;
receiving from the RFID tag, within the other inventory round, a third reply backscatter-modulated on the third RF signal and a fourth reply backscatter-modulated on the fourth RF signal;
determining a second set of phase differences associated with the third reply and the fourth reply;
attempting to correlate the second set of phase differences to at least a second plurality of candidates, wherein each candidate is associated with a respective location;
estimating, based on the attempted correlation of the second set of phase differences, a second location of the RFID reader antenna; and
estimating, based on at least the first location and the second location, a movement of the RFID reader antenna.

13. The method of claim 11, wherein the RFID tag is one of stationary and moving.

14. A method for a radio frequency identification (RFID) system to estimate a velocity of an RFID reader antenna, the method comprising:
transmitting, within a first inventory round, a first set of successive RF signals, wherein each RF signal in the first set of RF signals has a different frequency;
receiving a first set of replies from an RFID tag during the first inventory round, wherein at least two replies in the first set of replies are each backscatter-modulated on a different RF signal in the first set of RF signals;
transmitting, within a second inventory round, a second set of successive RF signals, wherein each RF signal in the second set of RF signals has a different frequency;
receiving a second set of replies from the RFID tag during the second inventory round, wherein at least two replies in the second set of replies are each backscatter-modulated on a different RF signal in the second set of RF signals;
determining a first set of phase differences associated with the first set of replies;
determining a second set of phase differences associated with the second set of replies;
attempting to correlate the first set of phase differences and the second set of phase differences to a plurality of candidates, wherein each candidate is associated with a respective candidate velocity of the RFID reader antenna; and
estimating, based on the attempted correlation, the velocity of the RFID reader antenna.

15. The method of claim 14, wherein the RFID tag is one of stationary and moving.
